(19) United States
(12) Patent Application Publication
(10) Pub. No.: US 2019/0065369 A1
(43) Pub. Date: Feb. 28, 2019

(54) INFORMATION PROCESSING APPARATUS, METHOD AND NON-TRANSITORY COMPUTER-READABLE STORAGE MEDIUM

(71) Applicant: FUJITSU LIMITED, Kawasaki-shi (JP)

(72) Inventors: Hidetoshi SATOU, Kawasaki (JP); Akiko Sakaguchi, Yokohama (JP); Atsuhiro Otaka, Kawasaki (JP); MIHOKO MAEDA, Kawasaki (JP)

(73) Assignee: FUJITSU LIMITED, Kawasaki-shi (JP)

(21) Appl. No.: 16/108,906

(22) Filed: Aug. 22, 2018

(30) Foreign Application Priority Data
Aug. 29, 2017 (JP) 2017-164296

(51) Int. Cl. G06F 12/02; G06F 9/50

(52) U.S. Cl. CPC G06F 12/0284; G06F 12/0246; G06F 2209/5014; G06F 2212/7202; G06F 9/5016

(57) ABSTRACT

An information processing apparatus includes a memory, and a processor coupled to the memory and configured to set, in the memory, a first region having a first capacity, receive a first request which requests to change the first region to a second region having a second capacity greater than the first capacity, set, in the memory, the second region and a reserved region in response to the first request, and cancel a setting of the reserved region when a second request which requests to change the second region to a third region having a third capacity greater than the second capacity is not received within a first time period after the first request is received.

### CROSS-REFERENCE TO RELATED APPLICATION

This application is based upon and claims the benefit of priority of the prior Japanese Patent Application No. 2017-164296, filed on Aug. 29, 2017, the entire contents of which are incorporated herein by reference.

### FIELD

The embodiments discussed herein are related to an information processing apparatus, a method and a non-transitory computer-readable storage medium.

### BACKGROUND

Memory management for managing a memory that stores a program, data, and the like is performed in a computer.

In the memory management, for example, a memory control apparatus included in the computer performs processes including acquisition of a memory area, expansion of the acquired memory area, release of the memory area, and the like in accordance with requests from the program. Related-art literatures include Japanese Laid-open Patent Publication No. 2003-131938, Japanese Laid-open Patent Publication No. 2007-34556, and Japanese Laid-open Patent Publication No. 2007-310626.

### SUMMARY

According to an aspect of the invention, an information processing apparatus includes a memory, and a processor coupled to the memory and configured to set, in the memory, a first region having a first capacity, receive a first request which requests to change the first region to a second region having a second capacity greater than the first capacity, set, in the memory, the second region and a reserved region in response to the first request, and cancel a setting of the reserved region when a second request which requests to change the second region to a third region having a third capacity greater than the second capacity is not received within a first time period after the first request is received.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a functional configuration example of a computer.

FIG. 2 illustrates an example of a memory area acquired from a storage area by a memory management unit.

FIG. 3 illustrates an example of a memory acquisition procedure.

FIG. 4 illustrates an example of a memory release procedure.

FIG. 5 illustrates an example of a memory expansion procedure.

FIG. 6 illustrates an example in a case where an expansion of a memory area is repeatedly performed.

FIG. 7 is a block diagram illustrating a functional configuration example of a computer according to one exemplary embodiment.

FIG. 8 illustrates an example in a case where the memory area is redundantly secured.

FIG. 9 illustrates an example of a memory size in a case where a reserved area is added to all of secured areas.

FIG. 10 is a block diagram illustrating a configuration example of a storage system according to the one exemplary embodiment.

FIG. 11 is a block diagram illustrating a functional configuration example of a control apparatus according to the one exemplary embodiment.

FIG. 12 illustrates an example of a manner of using a memory in accordance with a type used in a program.

FIG. 13 illustrates an example of a first table.

FIG. 14 illustrates an example of a second table.

FIG. 15 illustrates an example of a memory area expansion procedure according to the one exemplary embodiment.

FIG. 16 is a flow chart illustrating an example of memory acquisition processing.

FIG. 17 is a flow chart illustrating an example of memory expansion processing.

FIG. 18 is a flow chart illustrating an example of processing during an initial setting illustrated in FIG. 17.

FIG. 19 is a flow chart illustrating an example of the processing during the initial setting illustrated in FIG. 17.

FIG. 20 is a flow chart illustrating an example of the processing during the initial setting illustrated in FIG. 17.

FIG. 21 is a flow chart illustrating an example of processing during a normal operation illustrated in FIG. 17.

FIG. 22 is a flow chart illustrating an example of the processing during the normal operation illustrated in FIG. 17.

FIG. 23 is a flow chart illustrating an example of the processing during the normal operation illustrated in FIG. 17.

FIG. 24 is a flow chart illustrating an example of memory release processing.

FIG. 25 is a flow chart illustrating an example of monitoring processing.

FIG. 26 is a flow chart illustrating an example of the monitoring processing.

### DESCRIPTION OF EMBODIMENTS

When a memory control apparatus expands an acquired memory area, in a case where a memory area contiguous to a memory address of the memory area is already used, the memory area is reallocated to a memory area having a contiguous memory address with a size after the expansion (Re-allocation). The reallocation includes memory copy processing for copying data of the original memory area to the memory area at the reallocation destination.

The original memory area is released by the above-mentioned reallocation. However, a memory area that can be used by the release is, for example, a memory area having a limited size which is sandwiched back and forth by already used memory areas.

Therefore, in an environment where a program for causing processes such as acquisition, expansion, and release of the memory area is frequently executed, when the reallocation of the memory area is repeatedly performed, fragmentation of the memory may progress. According to this, even when a free space of the memory is sufficient, a memory area having a certain size with a contiguous memory address (for example, a size smaller than the free space) is not secured in some cases.

As described above, it becomes difficult to acquire a storage area having a desired size in the memory in some cases in the computer where the memory management is performed.

Hereinafter, exemplary embodiments of the present disclosure will be described with reference to the drawings. It is noted that a part assigned with the same reference symbol represents the same or similar part unless specifically mentioned in the drawings used in the following exemplary embodiments.

### [1] One Exemplary Embodiment

[1-1] Regarding Memory Management

Hereinafter, memory management according to one exemplary embodiment will be described. The ‘memory management’ is a technique for performing acquisition of a memory area (hereinafter, which may be referred to as ‘memory acquisition’ in some cases) and release of the memory area (hereinafter, which may be referred to as ‘memory release’ in some cases) in accordance with requests from the program such as processes and tasks.

The memory acquisition is, for example, a technique for dynamically allocating a part of storage area of the memory (memory area) to the program. The memory release is technique with which, when the allocated memory area becomes unwanted, this program or the other program can use the memory area again.

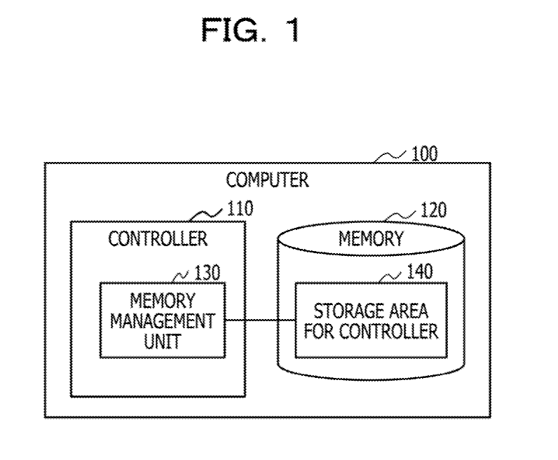

For example, as illustrated in FIG. 1, the memory management may be performed in a computer 100 provided with a controller 110 and a memory 120. In the example of FIG. 1, a memory management unit 130 of the controller performs the memory management with respect to a storage area for the controller of the memory 120 (hereinafter, which may be simply referred to as ‘storage area’ in some cases) 140.

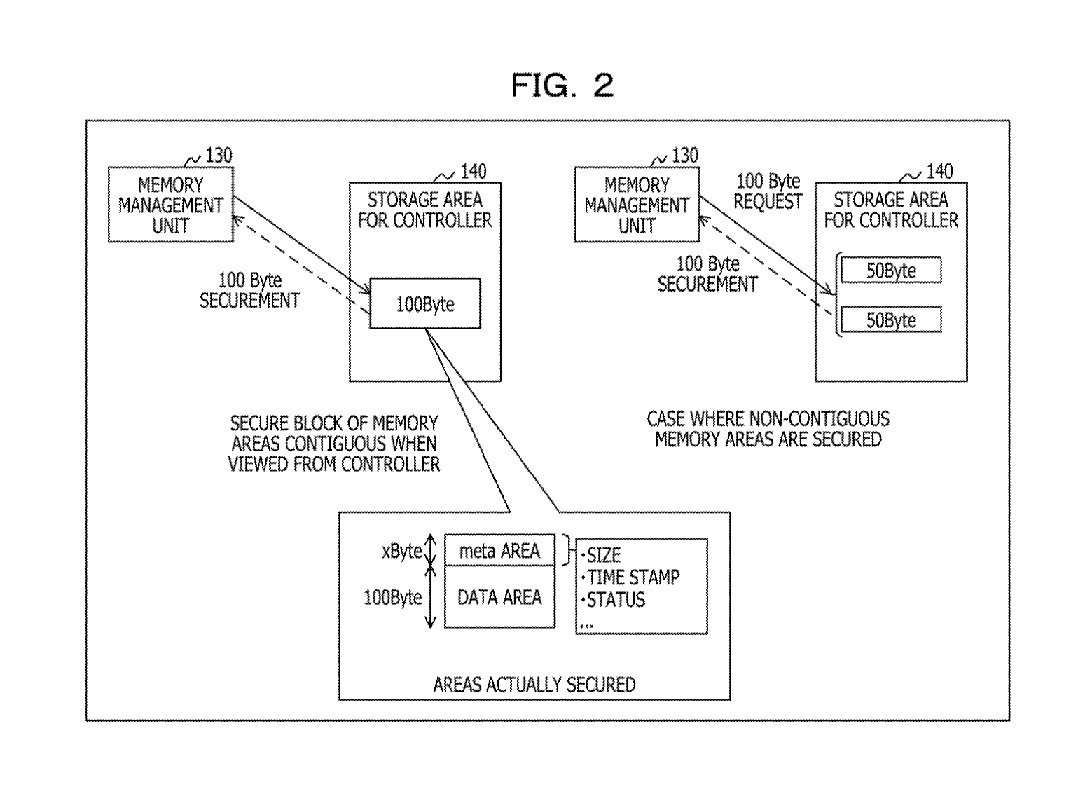

As exemplified in FIG. 2, the memory area acquired from the storage area 140 by the memory management unit 130 in the memory management is not a non-contiguous memory area (the right side in FIG. 2) but is a block of memory areas (for example, memory addresses are contiguous) which are contiguous (the right side in FIG. 2) when viewed from the controller 110.

It is noted that, in a case where the memory management unit 130 secures a memory area by the amount corresponding to 100 Bytes of the storage area 140 with respect to a request of 100 Bytes, in actuality, not only a data area of 100 Bytes but also a meta area for smoothly performing the memory management are secured.

The meta area may be an area of approximately several Bytes (which is referred to as xByte in the example of FIG. 2), and by way of illustration, information including a size of the secured data area, a time stamp, and a status such as being in use or already released may be set. At least one piece of information including the size, the time stamp, and the status may be set in the meta area as attribute information. It is noted that the meta area may be a management header area prepended to the data area, for example.

In the following descriptions, for convenience, a size of the memory area acquired, expanded, or released by the memory management is represented by a size of the requested data area but, in actuality, as exemplified in FIG. 2, the meta area is further included.

As a technique for presenting physically non-contiguous memory areas (for example, memory addresses are not contiguous) as contiguous memory areas (hereinafter, which may be referred to as ‘contiguous areas’ in some cases) when viewed from the program, various countermeasures have been discussed.

As an example, a virtual storage method (or a segment method or a paging method) has been proposed. According to the virtual storage method, when non-contiguous memory areas are combined with each other, it is possible to present the contiguous memory areas when viewed from the controller 110 (control program). In addition, with regard to the size of the memory area, a larger memory area can be secured without a constraint of the physical individual free spaces.

However, the virtual storage method is realized by an advanced memory management mechanism, and a support based on expensive hardware is to be used to obtain a realistic performance by the virtual storage method. For this reason, it is difficult to use the virtual storage method for all the computers 100 including the controller 110 and the memory 120.

According to the one exemplary embodiment, a technique for setting the memory 120 that does not use the virtual storage method as a target and guaranteeing the acquisition of the contiguous memory areas by the memory management with respect to the memory 120 will be described.

Hereinafter, the technique for the memory management executed in the computer 100 will be described. It is noted that the technique for the memory management which will be described below may also be executed according to the one exemplary embodiment.

[1-1-1] Technique for the Memory Acquisition

To secure the contiguous areas in the memory management, the memory management unit 130 searches the storage area 140 for an area where the requested contiguous areas can be secured (in other words, ‘free space’) before the memory acquisition is performed. Various techniques may be employed to search for the free space.

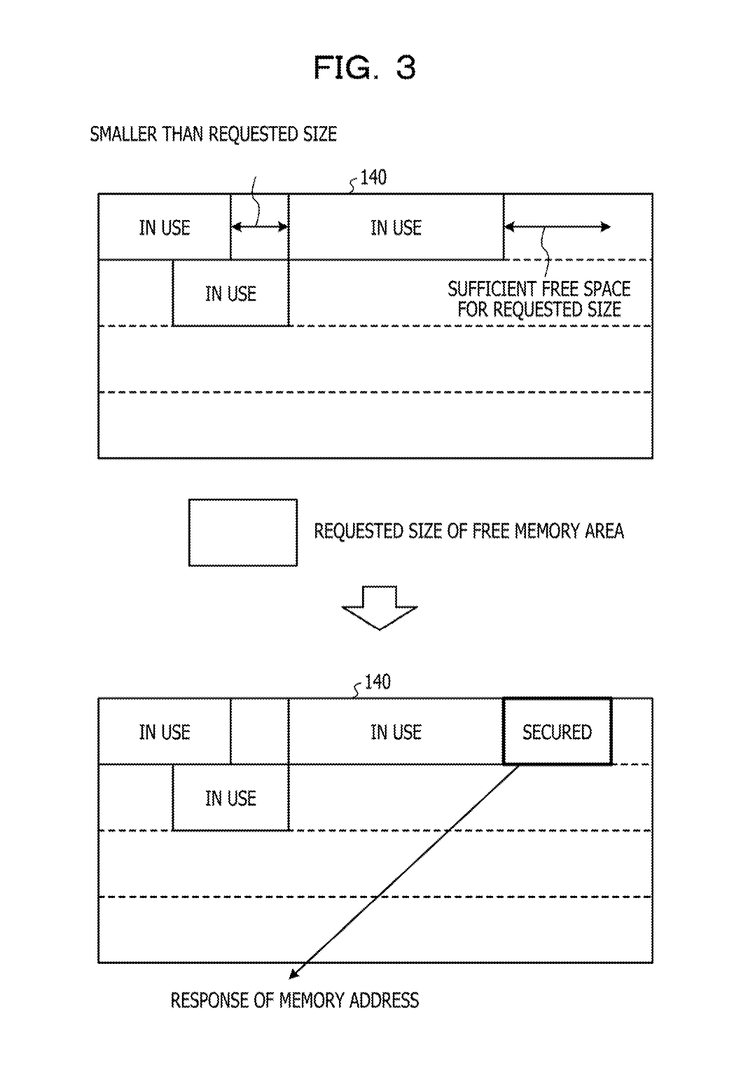

For example, as illustrated in an upper part of FIG. 3, to avoid fragmentation of the free space in the storage area 140, the memory management unit 130 may search for an area where the requested memory size can be contained with as little gap as possible. The memory management unit 130 may also respond a memory address of the secured memory area to a memory acquisition request source (for example, the program) as illustrated in a lower part of FIG. 3.

[1-1-2] Technique for the Memory Release

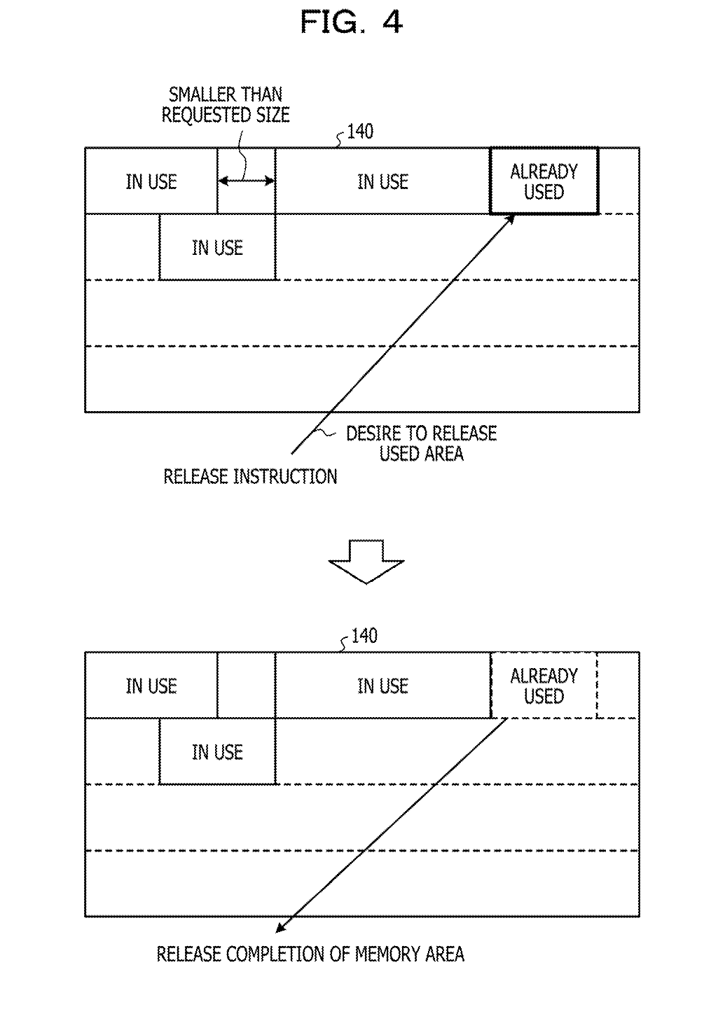

When the memory management unit 130 receives a memory release instruction from the program (see an upper part of FIG. 4), the memory management unit 130 manages by releasing the memory area related to the memory release instruction such that this memory area can be used again (see a lower part of FIG. 4).

The release of the memory area may include, for example, an update (marking) of a status in the meta area from information indicating being in use to information indicating being already released. The memory management unit 130 may also perform combining of the free spaces when appropriate.

For example, in the lower part of FIG. 4, it is supposed that the used memory area has 100 Bytes, and the contiguous area following the used memory area (for example, memory addresses are contiguous) has 300 Bytes. In this state, in a case where the memory area is released and the free space of 100 Bytes and the free space of 300 Bytes are separately managed, the free space of 400 Bytes originally exists, but an arrangement (securement) of a memory area having a size larger than 300 Bytes is not performed.

The combining of the free spaces is processing for suppressing the above-mentioned inconvenience and is a technique for combining a plurality of adjacent free spaces which are separately managed to each other at the time of the memory release to be managed as a single free space (for example, an area having 400 Bytes) having contiguous memory addresses.

[1-1-3] Technique for the Memory Expansion

Basic techniques for the memory management include the memory acquisition and the memory release described above, but an expansion of the memory area (hereinafter, which may be referred to as ‘memory expansion’ in some cases) is proposed as an application of these techniques. The memory expansion may also be referred to as ‘memory expansion acquisition’.

The memory expansion is implemented by a command “realloc” in C language and is a technique for specifying a location of the currently used memory area and a newly requested memory size to acquire the memory area again by the following procedure.

For example, the memory management unit 130 compares the size of the originally acquired memory area with the newly requested memory size and performs one of the following processes in accordance with a comparison result.

(a) When the comparison result indicates that the size of the originally acquired memory area is the same as the newly requested memory size, the memory management unit 130 notifies the program corresponding to the memory expansion request source of the information of the originally acquired memory area (for example, the memory address) without performing the acquisition of the new memory area.

(b) When the newly requested memory size is smaller than the size of the originally acquired memory area, the memory management unit 130 releases an unwanted area out of the originally acquired memory area and notifies the program of the information of the originally acquired memory area.

(c) When the newly requested memory size is larger than the size of the originally acquired memory area, the memory management unit 130 performs one of the following processes.

(c-1) When the expansion can be performed while the current arrangement of the memory area is maintained (when the contiguous area following the memory area is a free space, for example), the memory management unit 130 acquires the newly requested memory size and notifies of the program of the information of the originally acquired memory area.

(c-2) When the expansion is not performed if the current arrangement of the memory area is maintained, the memory management unit 130 obtains the memory area where the newly requested memory size can be acquired from the storage area 140 again. The memory management unit 130 then copies the contents of the originally acquired memory area in the newly acquired memory area and releases the originally acquired memory area. Thereafter, the memory management unit 130 notifies the program of the information of the newly acquired memory area.

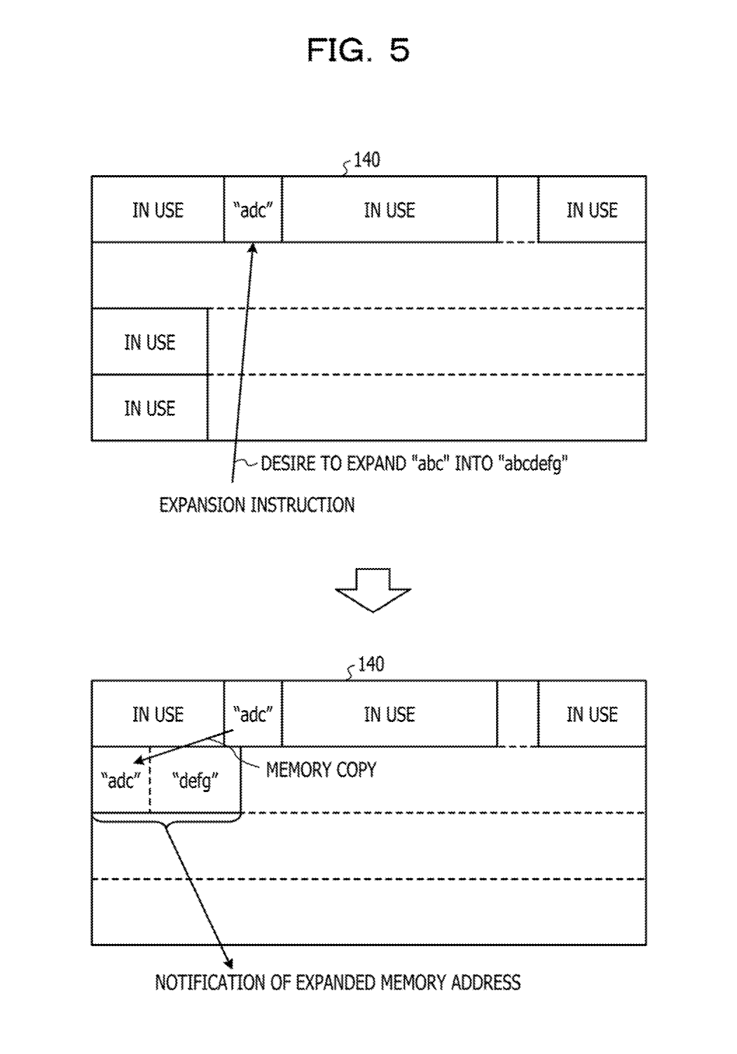

FIG. 5 illustrates an example of the processing of (c-2) described above. As exemplified in an upper part of FIG. 5, the memory management unit 130 accepts an expansion instruction for expanding the already established memory area where “abc” is stored into a memory area where “abcdefg” can be stored from the program. In this case, since the contiguous area following the memory area where “abc” is stored is in use, the memory management unit 130 acquires a new memory area where “abc”+“defg” can be stored as exemplified in a lower part of FIG. 5 and copies “abc” from the memory area into the new memory area. The memory management unit 130 then releases the memory area and thereafter notifies the program of the information of the new memory area.

As described above, since the memory area is acquired in a manner that the gap is reduced in the memory acquisition processing, in a case where the memory management unit 130 performs the memory expansion processing, the reacquisition processing of the memory area which is accompanied by the memory copy as illustrated in (c-2) described above is performed in many cases.

On the other hand, in a high-level language such as C++, “types” having a function for expanding the used memory area when an area for a variable becomes deficient without a realization of a user are defined like a “string” type, an “std::vector” type, and the like. For this reason, when a large number of those types are used, there is a possibility that the memory reallocation may occur in high volume without the realization of the user.

In addition, the expansion processing of the once secured memory area is frequently executed in some cases depending on the program of the controller 110 using the memory 120, and a case is conceivable where the reallocation of the memory area occur in high volume in accordance with the control contents of the program.

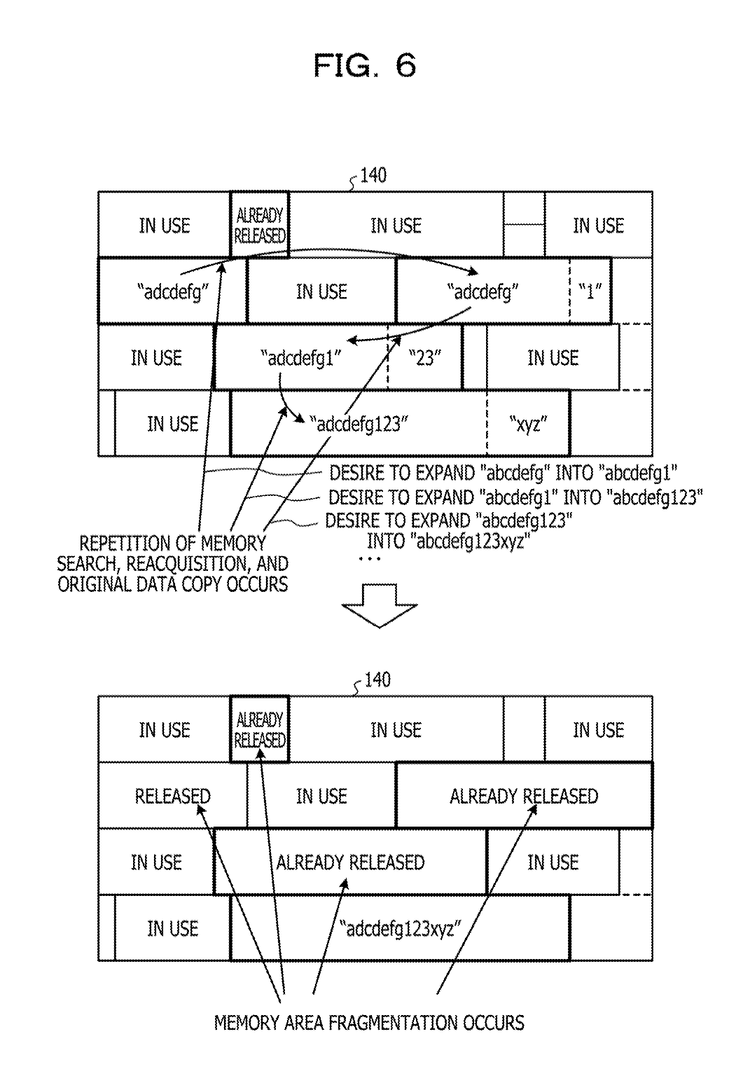

FIG. 6 illustrates an example of a case where the used memory size is further repeatedly and gradually expanded with respect to the newly acquired memory area in FIG. 5. In the example of FIG. 6, the reacquisition of the memory area is performed each time the memory area is expanded.

For example, the reacquisition processing of the memory area which is accompanied by the memory copy is performed by the following procedure in an upper part of FIG. 6.

(i) When a memory area where “abcdefg” can be stored is reacquired, “abc” is copied in the memory area (see FIG. 5).

(ii) When a memory area where “abcdefg1” can be stored is reacquired, “abcdefg” is copied in the memory area.

(iii) When a memory area where “abcdefg123” can be stored is reacquired, “abcdefg1” is copied in the memory area.

(iv) When a memory area where “abcdefg123xyz” can be stored is reacquired, “abcdefg123” is copied in the memory area.

As described above, the copying of the same data has occurred plural times in the procedure from (i) to (iv). In this manner, when the data copy frequently occurs in the memory management, there is a possibility that the processing performance of the controller 110 may be decreased.

The originally used memory area becomes unwanted and released by the reallocation of the memory area, but as a result of the repetition of the reallocation of the memory area as exemplified in a lower part of FIG. 6, the fragmentation of the memory (the storage area 140) may progress in some cases.

A method of performing the reallocation of the memory area (which may also be referred to as ‘memory compaction’) is included as a technique for filling the gap in the fragmented memory. However, to adopt this technique, a dedicated-use mechanism for notifying the program side of a location of the memory area after the reallocation by any method is to be provided with respect to the controller 110. In this manner, an inconvenience may occur, for example, that it becomes difficult to notify the program side of the reallocation of the memory area, and it is difficult to simply execute the reallocation of the memory area in the controller 110.

In addition, decrease in a response of the controller 110 may be triggered by the repetition of the memory copy in a small-capacity memory having a low-speed access performance in some cases.

As described above, the number of cases where the memory copy further occurs is increased as the fragmentation of the memory progresses, which may cause a negative spiral.

In view of the above, according to an exemplary embodiment which will be described in detail below, a technique for reducing the occurrence frequency of the memory copy while the fragmentation of the memory is avoided will be described.

[1-2] Regarding the One Exemplary Embodiment

[1-2-1] Descriptions of the One Exemplary Embodiment

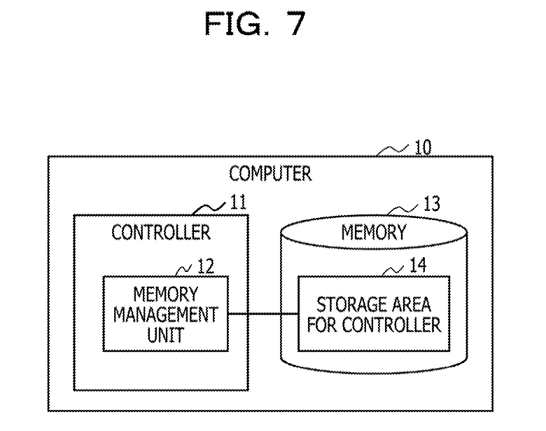

FIG. 7 is a block diagram illustrating a configuration example of a computer 10 as an example of one exemplary embodiment. As illustrated in FIG. 7, the computer 10 according to the one exemplary embodiment may be provided with a controller 11 and a memory 13 by way of illustration.

The controller 11 performs various controls in the computer 10. The controller 11 may be provided with a memory management unit 12 that performs processing related to the memory 13 in an operation of the controller 11.

The memory management unit 12 is an example of the memory control apparatus that performs various memory managements with respect to at least a part of storage area included in the memory 13. Hereinafter, a storage area of the memory 13 managed by the memory management unit 12 will be referred to as a storage area for the controller (hereinafter, which may be simply referred to as ‘storage area’ in some cases) 14.

It is noted that the computer 10 (the controller 11) can perform processing similar to the memory management including, for example, the memory acquisition, the memory release, and the memory expansion by the computer 100 (the controller 110) illustrated in FIG. 1. In the following explanation, descriptions of processing for determining whether or not the requested memory area can be secured based on a free space situation of the entire storage area 14 in the above-mentioned memory management processing will be omitted.

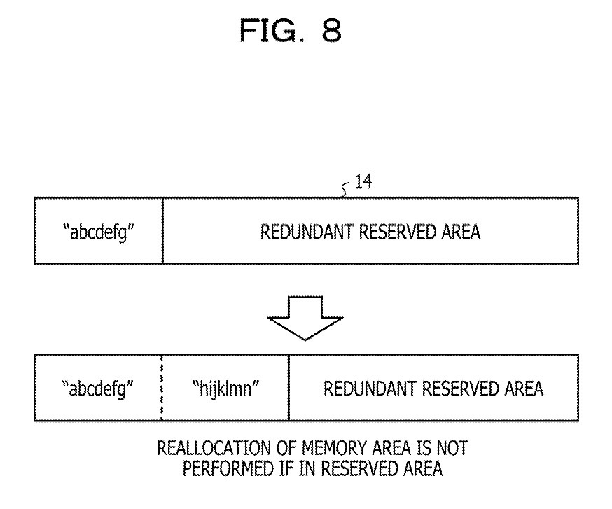

The inconvenience according to the one exemplary embodiment which has been described with reference to FIGS. 3 to 6 can be addressed in some cases by redundantly securing the memory area in the storage area 14 in advance, for example, as exemplified in FIG. 8. According to this, when the size is simply contained in the reserved area, the used memory area can be expanded without the copying of the memory area even with respect to the plural expansion requests in accordance with the above-mentioned case (c-1), and it is possible to decrease the number of times to perform the memory copy.

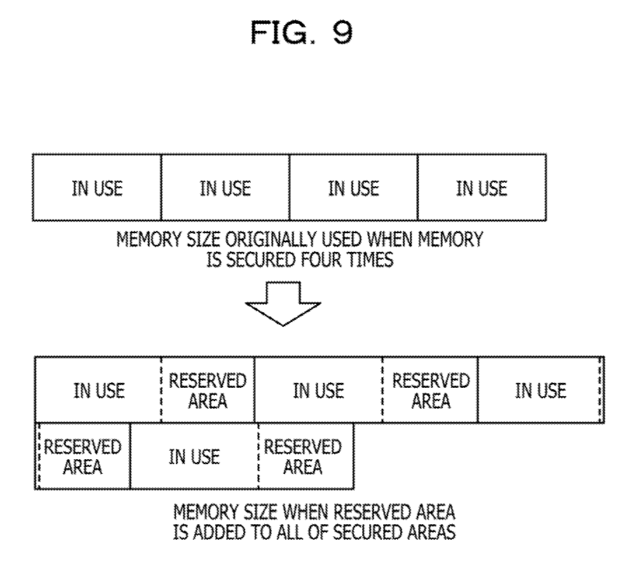

However, according to this technique, when the redundant memory area is secured at the time of the acquisition of all of the memory areas, as exemplified in FIG. 9, the memory consumption is increased, and a probability that a majority of the secured memory area is wasted is high. In view of the above, a technique with which the reserved area is not excessively secured will be described below.

For example, in a case where the memory acquisition is performed at the beginning based on a securement request of the memory area from the program, the memory management unit 12 of the controller 11 may secure a memory size specified by the securement request of the memory area.

In a case where a memory expansion acquisition request is received from the program, the memory management unit 12 may also redundantly secure the reserved area in addition to the memory size specified by the expansion acquisition request.

At this time, the memory management unit 12 may determine an expanded memory size based on the memory size related to the first memory expansion request, the memory size specified by the immediately preceding memory expansion acquisition request, or the like. It is noted that the expanded memory size may also be a size calculated by summing up the memory size specified by the memory expansion acquisition request and the size of the reserved area.

In addition, in a case where the expansion acquisition request with respect to the reserved area has not arrived within a specified time, the memory management unit 12 may release the reserved area to be restored as the free space.

With the above-mentioned processing, the controller 11 according to the one exemplary embodiment can suppress performance degradation at the time of the memory reallocation by decreasing the number of times to perform the memory copy while the fragmentation of the memory area is taken into account.

[1-2-2] Configuration Example of the One Exemplary Embodiment

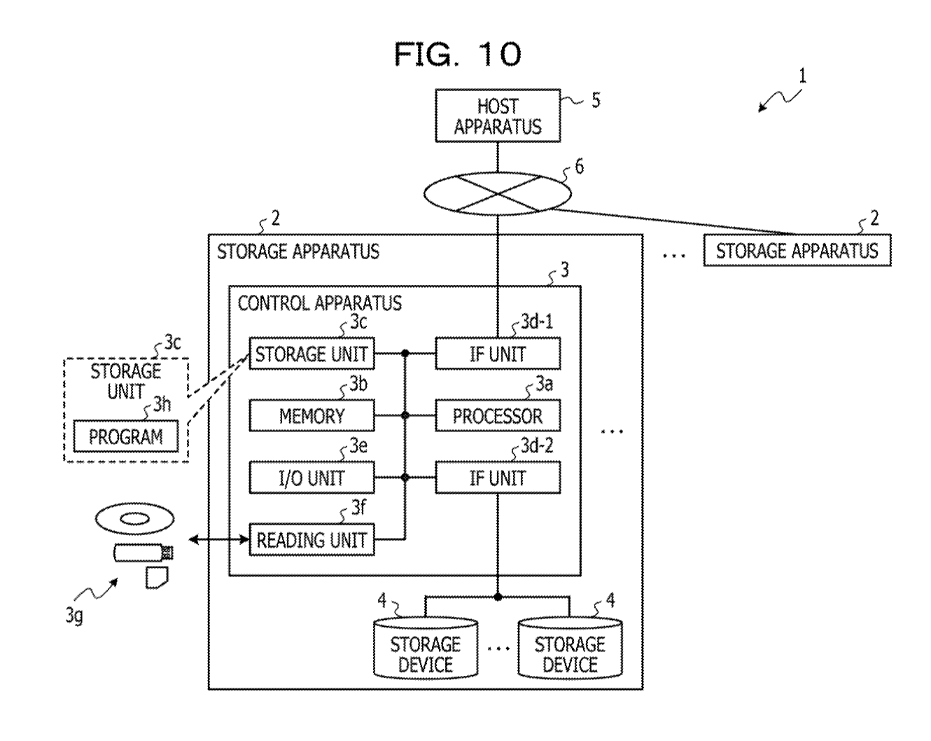

FIG. 10 is a block diagram illustrating a configuration example of a storage system 1 as an example of the one exemplary embodiment. As illustrated in FIG. 10, the storage system 1 according to the one exemplary embodiment may be provided with one or more storage apparatuses 2 (a plurality of storage apparatuses 2 in the example of FIG. 10) and a host apparatus 5 by way of illustration.

The storage apparatus 2 may be provided with one or more control apparatuses 3 and one or more storage devices 4 (a plurality of storage devices 4 in the example of FIG. 4) by way of illustration and may provide a storage area of the storage device 4 with respect to the host apparatus 5. For example, the storage apparatus 2 may save the data in a dispersed or redundant state in the plurality of storage devices 4 by using redundant arrays of inexpensive disks (RAID).

The control apparatus 3 is also an example of an information processing apparatus or a control apparatus that controls various input/output (I/O) processes with respect to the plurality of storage devices 4 from the host apparatus 5. The control apparatus 3 is also an example of the computer 10 illustrated in FIG. 7. In other words, the computer 10 may be an apparatus that performs various controls in the storage apparatus 2.

The storage device 4 is an example of hardware that stores various pieces of data, programs, and the like. The storage device 4 includes, for example, a semiconductor drive device such as a solid state drive (SSD), a non-volatile memory, a magnetic disc device such as hard disk drive (HDD), and the like. The non-volatile memory includes, for example, a flash memory, a storage class memory (SCM), a read only memory (ROM), and the like.

It is noted that the storage apparatus 2 is provided with a control casing that stores the control apparatus 3 and a storage casing to which the storage device 4 is mounted, and the plurality of storage apparatuses 2 may constitute a scale-out type storage system. It is noted that the storage device 4 may be mounted in both the control casing and the storage casing in this case.

The host apparatus 5 issues various I/O processes such as a write request and a read request with respect to one or more storage apparatuses 2 via a network 6. The host apparatus 5 includes, for example, a computer such as a business server, a backbone server, or a client machine. FIG. 10 illustrates the single host apparatus 5, but the plurality of host apparatus 5 may also exist in the storage system 1.

The network 6 may include, for example, a storage area network (SAN) and may also include a network device such as one or more switches which are not illustrated in the drawing. The network 6 may also include the internet or a local area network (LAN), a wide area network (WAN), or the like. The storage apparatus 2 and the host apparatus 5 may be coupled to each other via the network 6 such as, for example, an optical cable in conformity to Fibre Channel (FC) or Internet Small Computer System Interface (ISCSI) or an Ethernet (registered trademark) cable.

(Hardware Configuration Example)

Next, a hardware configuration example of the control apparatus 3 will be described with reference to FIG. 10. As illustrated in FIG. 10, the control apparatus 3 may be provided with a processor 3a, a memory 3b, a storage unit 3c, interface (IF) units 3d-1 and 3d-2, an I/O unit 3e, and a reading unit 3f by way of illustration.

The processor 3a is an example of an arithmetic processing unit that performs various controls and arithmetic operations. The processor 3a may be coupled to the respective blocks 3b to 3f by a bus so as to be communicable with each other. An integrated circuit (IC) such as a CPU, an MPU, a DSP, an ASIC, or an FPGA may be used as the processor 3a. It is noted that the CPU is an abbreviation of a central processing unit, and the MPU is an abbreviation of a micro processing unit. The DSP is an abbreviation of a digital signal processor. In addition, the ASIC is an abbreviation of an application specific integrated circuit, and FPGA is an abbreviation of a field programmable gate array.

The memory 3b is an example of hardware that stores the various pieces of data and the program. The memory 3b includes, for example, a volatile memory such as a random access memory (RAM). It is noted that a part of the storage area of the memory 3b may be used as a cache memory that temporarily stores data used for an access or the like to the storage device 4 or the program.

The storage unit 3c is an example of hardware that stores the various pieces of data, the program, and the like. For example, various storage apparatuses including the magnetic disc device such as the HDD, the semiconductor drive device such as the SSD, and the non-volatile memory are exemplified as the storage unit 3c. The storage unit 3c may store a program 3h that realizes all or a part of various functions of the control apparatus 3. The processor 3a develops the program 3h stored in the storage unit 3c into the memory 3b to be executed, for example, so that the functions of the control apparatus 3 can be realized.

The IF unit 3d-1 is an example of a communication interface that performs control on the coupling and communication with the host apparatus 5 and the like. The IF unit 3d-2 is an example of a communication interface that performs control on the coupling and communication with the storage device 4 and the like. The control apparatus 3 may also be provided with a communication interface that performs control on the coupling and communication with an operating terminal of an operator, and the program 3h may be downloaded from the network 6 or another network which is not illustrated in the drawing by using the communication interface.

The I/O unit 3e may include at least a part of input units such as a mouse, a key board, and an operation button and at least a part of output units such as a display and a printer.

The reading unit 3f is an example of a reader that reads out the data or the program recorded in a recording medium 3g. The reading unit 3f may include a connection terminal or an apparatus to which the recording medium 3g can be coupled or inserted. The reading unit 3f includes, for example, an adapter in conformity to a universal serial bus (USB) or the like, a drive device that performs an access to a recording disc, a card reader that performs an access to a flash memory such as an SD card, and the like. It is noted that the program 3h may be stored in the recording medium 3g.

A non-transitory computer-readable recording medium such as a magnetic/optical disc or a flash memory is exemplified as the recording medium 3g by way of illustration. The magnetic/optical disc includes a flexible disc, a compact disc (CD), a digital versatile disc (DVD), a blue-ray disc, a holographic versatile disc (HVD), and the like by way of illustration. The flash memory includes a USB memory, an SD card, and the like by way of illustration. It is noted that the CD includes CD-ROM, CD-R, CD-RW, and the like by way of illustration. In addition, the DVD includes DVD-ROM, DVD-RAM, DVD-R, DVD-RW, DVD+R, DVD+RW, and the like by way of illustration.

The above-mentioned hardware configuration of the control apparatus 3 is an exemplification. Therefore, increase or decrease in the number of hardware devices in the control apparatus 3 (for example, addition or removal of an arbitrary block), division, integration of an arbitrary combination, addition of a bus, omission, or the like may be appropriately performed.

(Functional Configuration Example)

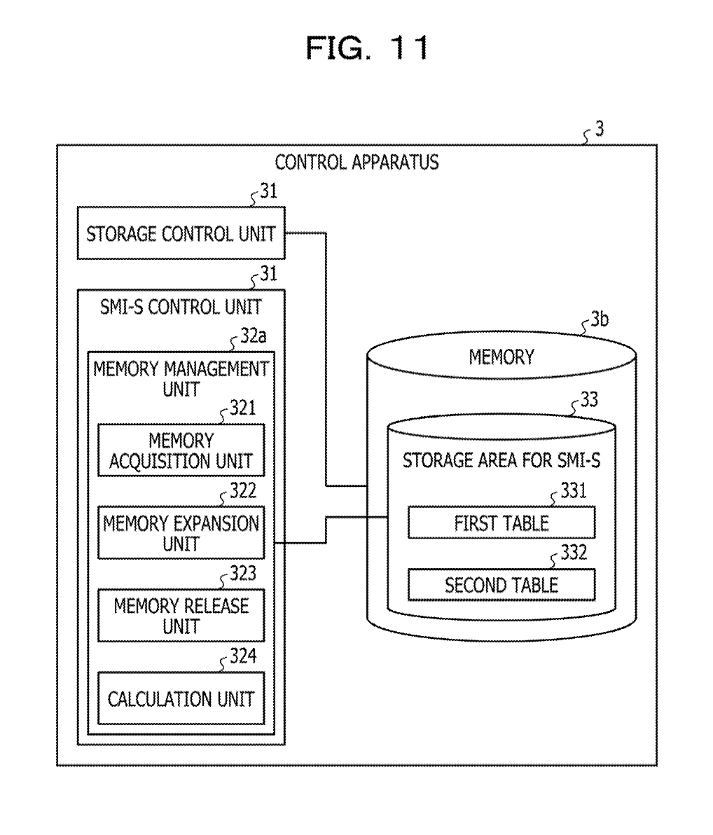

Next, a functional configuration example of the control apparatus 3 will be described with reference to FIG. 11. FIG. 11 is a block diagram illustrating a functional configuration example of the control apparatus 3 according to the one exemplary embodiment. As illustrated in FIG. 11, the control apparatus 3 may be provided with a storage control unit 31 and an SMI-S control unit 32 by way of illustration. SMI-S is an abbreviation of Storage Management Initiative—Specification.

The storage control unit 31 performs various controls in the storage apparatus 2 including controls with respect to the host apparatus 5 and the storage device 4.

The SMI-S control unit 32 performs control with regard to SMI-S. SMI-S is a standard specification related to a storage developed and maintained by Storage Networking Industry Association (SNIA) and provides a common storage management function and an access to the function. Unlike a unique management IF, according to SMI-S, a management application can support a wide range of storage apparatuses from a plurality of vendors by using the standard IF.

SMI-S is based on Common Information Model and Web-Based Enterprise Management defined by Distributed Management Task Force and is authorized as ANSI INCITS 388-2004 of ANSI standards. ANSI is an abbreviation of American National Standards Institute.

As exemplified in FIG. 11, the SMI-S control unit 32 may be provided with a memory management unit 32a. The memory management unit 32a is an example of the memory management unit 12 illustrated in FIG. 7.

The memory management unit 32a is an example of the memory control apparatus. The memory management unit 32a secures a part of storage area in the memory 3b used by the control apparatus 3 as a dedicated-use storage area and separately performs memory management that is different from the memory management of the control apparatus 3 (for example, the storage control unit 31) to perform resource management of this storage area. For this reason, the SMI-S control unit 32 can perform the memory management closed in the SMI-S control unit 32 without sharing another program in the storage apparatus 2 and the memory 3b.

Hereinafter, the storage area managed by the memory management unit 32a is referred to as a storage area for SMI-S (which may also be simply referred to as ‘storage area’) 33. It is noted that, depending on a scale of the storage apparatus 2, the memory 3b may be a size of approximately 2 GBytes to 12 GBytes, and the storage area 33 may be a size of approximately 50 MBytes to 100 MBytes, for example.

The storage area 33 is an example of the memory used by the SMI-S control unit 32. The storage area 33 may store a first table 331 and a second table 332 as exemplified in FIG. 11. The first table 331 and the second table 332 are examples of information used for the memory management of the storage area 33 by the memory management unit 32a. Details of the first table 331 and the second table 332 will be described below.

It is noted that the virtual storage method has been proposed with which contiguous memory areas can be presented when viewed from the controller 11 (control program) by combining the non-contiguous memory areas with each other as described above. However, it is difficult to apply the virtual storage method to the storage apparatus 2 or the SMI-S control program part since the support based on the expensive hardware is to be used to obtain the realistic performance.

In view of the above, as illustrated in FIG. 11, the memory management unit 32a of the SMI-S control unit 32 according to the one exemplary embodiment may be provided with a memory acquisition unit 321, a memory expansion unit 322, a memory release unit 323, and a calculation unit 324 by way of illustration.

The memory acquisition unit 321 may acquire the memory area from the storage area 33 in accordance with the memory acquisition request from the program such as, for example, the control program that realizes the function of the SMI-S control unit 32 (the same applies as follows).

For example, in a case where the memory acquisition is performed at the beginning, the memory acquisition unit 321 secures the exact memory size as requested from the storage area 33. It is noted that the detail of the technique for the memory acquisition has been already described, and the descriptions thereof will be omitted.

The memory expansion unit 322 may expand, in accordance with a memory expansion acquisition request (hereinafter, which may be simply referred to as ‘expansion request’ in some cases) from the program, the memory area specified by this request. The expansion of the memory area may include the reallocation of the memory areas. It is noted that, a detail of the processing in a case where the reallocation is not involved in the technique for the memory expansion (in a case where the memory area contiguous to the original memory area can be simply secured; the above-mentioned case (c-1)) has been already described, and the descriptions thereof will be omitted.

For example, in a case where the memory area is expanded by the reallocation, the memory expansion unit 322 redundantly secures a reserved area for a size calculated by the calculation unit 324 which will be described below in addition to the memory area specified by the expansion request. It is noted that the ‘reserved area’ may also be referred to as an ‘expanded area’.

In other words, the memory expansion unit 322 is an example of an expansion unit. In a case where a first expansion request including an instruction for expanding a memory area having a first size acquired from the storage area 33 into a second size obtained by adding the requested size to the first size is received, the expansion unit may acquire the reserved area having a predetermined size together with the storage area having the requested size from the storage area 33.

It is noted that the memory expansion unit 322 may perform the above-mentioned reallocation of the memory area. For example, the memory expansion unit 322 may compare a first total size of the memory area and the free space contiguous to the memory area in the storage area 33 with a second total size of the second size and the predetermined size. In a case where the first total size is smaller than the second total size, the memory expansion unit 322 may reallocate the memory area to the free contiguous area having at least the second total size in the storage area 33.

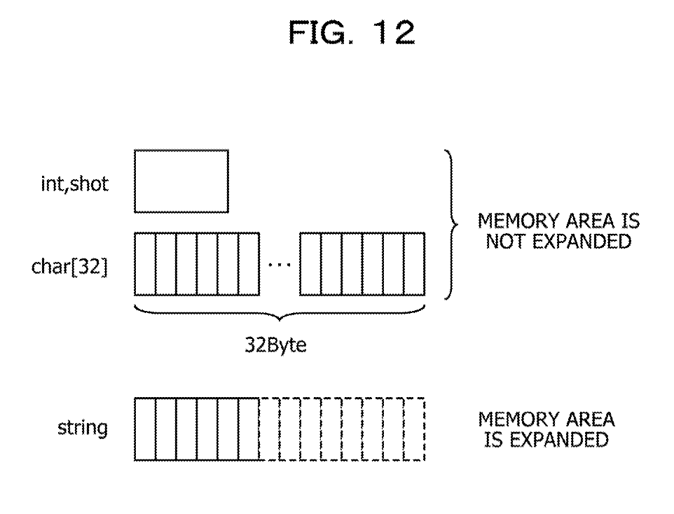

As exemplified in FIG. 12, from the viewpoint of the software or the program, the SMI-S control unit 32 may use the storage area 33 of the memory 3b in a mode illustrated in FIG. 12 in some cases. For example, with regard to an area for a variable declared in the “string” type or the “std::vector” type exemplified above, each time the area becomes insufficient, the SMI-S control unit 32 performs the memory expansion instruction to expand the memory area. On the other hand, as illustrated in FIG. 12, with regard to a numeric value data such as an “int” type or a “short” type, character array data having a fixed length such as a “char[32]”, or the like, once the area is secured, the size is not changed thereafter because of the nature of the program language.

In this manner, the data where the memory expansion is frequently performed is limited to some extent on the program side, and it can be mentioned that all of the storage areas 33 are not to be redundantly secured.

However, it is difficult for the memory management unit 32a in the memory management to recognize a manner how the program declares a variable and a scene in which the memory expansion is performed.

In view of the above, the memory acquisition unit 321 secures the exact memory size as requested in the above-mentioned manner in a case where the memory acquisition is performed at the beginning. After the first memory acquisition, only in a case where the memory area specified by the expansion acquisition is to be expanded by the reallocation, the memory expansion unit 322 redundantly secures the reserved area together with the memory area to be expanded.

As a condition where the reserved area is to be secured, a limitation is set on the memory area where the memory expansion request has issued once, but in this case too, if the acquired memory area (reserved area) is not used, the wasted memory area is secured in the end.

In view of the above, until a certain time has elapsed after the acquisition request or the expansion request of the memory area (which may also be referred to as ‘specified time’) is issued, in a case where the expansion request is not received with respect to the reserved area, the memory release unit 323 may release the reserved area to be restored as the free space.

In other words, the memory release unit 323 is an example of a release unit that releases the reserved area and restores the reserved area into the free space in a case where a second expansion request including an instruction for expanding the memory area to have a third size larger than the second size is not received within the specified time.

It is noted that, when the ‘certain time’ is excessively secured, for example, a time in which the wasted (unwanted) reserved area is not effectively used is lengthened. On the other hand, when the ‘certain time’ is insufficiently secured, irrespective of a situation where the expansion request is originally issued, the secured expanded area is released and used for another purpose. As a result, there is a possibility that the reallocation of the memory area occurs.

For this reason, the memory release unit 323 may set an appropriate time as the ‘certain time’.

For example, an operation phase of the SMI-S control unit 32 can be separated into two phases including an operation phase at the time of the program start (initial setting phase) and an operation phase at the time of the program operation (normal operation phase). A use method of the storage area 33 by the SMI-S control unit 32 differs in accordance with the operation phase.

In view of the above, the memory release unit 323 may determine a starting point for counting the ‘certain time’ until the memory area is released in accordance with the operation phase of the SMI-S control unit 32 as follows. It is noted that SMI-S regulates that a response is to be made with respect to a request from a client within 10 seconds. In the following descriptions, a ‘response allowed time’ (T) in which 10 seconds are set is used as the ‘certain time’.

(A-1) Case of the Operation Phase at the Time of the Program Start (Initial Setting Phase).

The storage apparatus 2 is activated, and after the start of the program of the SMI-S control unit 32, the initial setting is performed for a while. In the initial setting, the SMI-S control unit 32 prepares data to be used in operations in a later stage. For this reason, there is a possibility that the memory acquisition and the memory expansion of a relatively large size may be operated.

It is noted that the SMI-S control unit 32 performs a communication with another operating module in many cases to check a state of the storage apparatus 2 and an internal setting in the initial setting phase. As a result, the memory expansion request may be issued in some cases. For this reason, the SMI-S control unit 32 repeatedly performs the expansion of the memory area for a longer time by that of the normal operation phase and secures the memory area used for the processing.

While the above-mentioned operation of the initial setting phase is taken into account, the memory management unit 32a (for example, the memory expansion unit 322) may set a timer when the first expansion request is used as a trigger for each memory area and reset the count of the timer in a case where the next expansion request is issued. In other words, the memory expansion unit 322 may reset the time measurement of the certain time each time the processing related to the expansion request with respect to the memory area is executed.

The memory release unit 323 also measures time by the above-mentioned technique. In a case where a new memory expansion request is not issued with respect to the memory area for a certain time, for example, 10 seconds, the memory release unit 323 may release the memory area (expanded area). In other words, in a case where the next expansion request is not received within the certain time since the processing related to the immediately preceding expansion request is executed with regard to the memory area, the memory release unit 323 may release the reserved area acquired by the processing related to the immediately preceding expansion request to restore the reserved area into the free space.

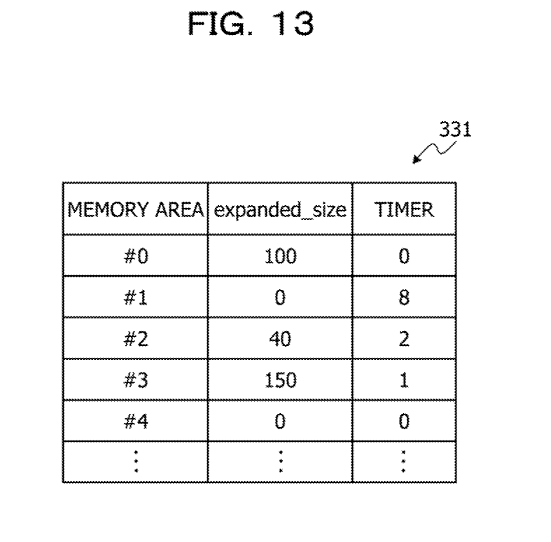

FIG. 13 illustrates an example of the first table 331 stored in the storage area 33. The first table 331 is an example of a table for monitoring the expanded memory area during the initial setting. As illustrated in FIG. 13, the first table 331 may store information of ‘memory area’, ‘expanded_size’, and ‘timer’ by way of illustration.

The ‘memory area’ is an example of identification information for identifying the respective memory areas. One entry for the single memory area may be provided in the first table 331. It is noted that an entry of the memory areas before and after the reallocation may exist in the first table 331 in a case where the reallocation of the memory area occurs. In this case, for example, information such as the number of updates or the memory addresses may be included in the entry so that the memory areas before and after the reallocation can be distinguished from each other. In addition, for example, an invalidation flag may be included in the entry to invalidate an old entry before the reallocation (or a timer of the entry) at a certain timing.

Then ‘expanded_size’ is information indicating a size’ of the expanded area set in the memory area. In a case where the expanded area is not set in the memory area, “0” may be set as the ‘expanded_size’. The ‘timer’ is an example of a timer that manages the release of the expanded area in the initial setting phase. Instead of the counted value after the setting or resetting, information of a time stamp at the time of the setting or resetting or the like may be set as the ‘timer’.

In this manner, the memory expansion unit 322 may create or update the entry in the first table 331 in the initial setting phase each time the expanded area is set and set the information of ‘expanded_size’ and ‘timer’. Then, the memory release unit 323 may refer to each entry in the first table 331 regularly (every second, for example) and perform processing for releasing the expanded area with regard to the memory area where the timing of the ‘timer’ has elapsed the certain time.

(B-1) Case of the Operation Phase at the Time of the Program Operation (Normal Operation Phase).

In the normal operation phase, in a case where the SMI-S control unit 32 operates while accepting a command from an external storage apparatus such as, for example, the other storage apparatus 2, the SMI-S control unit 32 operates while securing the memory area used for the command operation when appropriate.

Although the memory size used for the command operation and the memory size specified by the expansion request differ depending on a type of the command, the calculation of the memory size used for the command operation in the normal operation phase is completed in a short period of time as compared with the operation of the initial setting phase in most cases.

In addition, since SMI-S regulates the response allowed time of 10 seconds, it is conceivable that the processing related to the memory expansion request is completed in up to 10 seconds. In view of the above, the memory release unit 323 sets the timer for each memory area while the first expansion request is used as the trigger and does not reset the count of the timer also in a case where the next expansion request exists. In a case where 10 seconds have elapsed since the processing related to the first expansion request, the memory release unit 323 may release the memory area (expanded area).

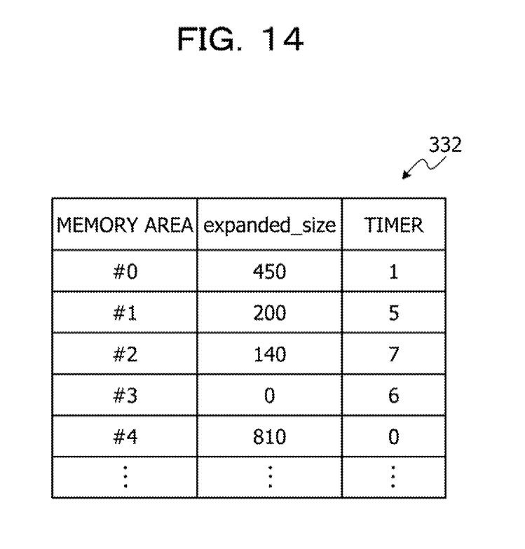

FIG. 14 illustrates an example of the second table 332 stored in the storage area 33. The second table 332 is an example of a table for monitoring the expanded memory area during the normal operation. As illustrated in FIG. 14, the second table 332 may store the information of ‘memory area’, ‘expanded_size’, and ‘timer’ by way of illustration.

The ‘memory area’, the ‘expanded_size’, and the ‘timer’ are respectively similar to the ‘memory area’, the ‘expanded_size’, and the ‘timer’ in the first table 331.

When the memory expansion unit 322 sets the first expanded area in the normal operation phase, the memory expansion unit 322 may create or update the entry in the second table 332 to set the information of ‘expanded_size’ and ‘timer’. Then, the memory release unit 323 may refer to each entry in the second table 332 regularly (every second, for example) and perform processing for releasing the expanded area with regard to the memory area where the timing of the ‘timer’ has elapsed the certain time.

As described above, a part of the memory area redundantly secured by the memory expansion unit 322 where it is determined that the part is not to be used is released by the memory release unit 323 based on the first table 331 and the second table 332 in second processing.

However, when the release of the memory area is performed by this technique after the certain time, ‘missing tooth’ free spaces as illustrated in FIG. 6 are scattered about, in other words, a probability that the fragmentation of the memory occurs is high. In a system where a long period of system operation is supposed (for example, the storage system 1), the number of the ‘missing tooth’ areas is preferably decreased as much as possible.

In view of the above, the calculation unit 324 may calculate the size of the expanded area at which the memory area to be released is reduced as much as possible in addition to the second processing. According to this, the amount of the memory area redundantly secured by the memory expansion unit 322 can be approximated to a theoretical value originally used by the program as much as possible.

In other words, the calculation unit 324 is an example of a determination unit that determines the predetermined size of the reserved area based on the second size specified by the first expansion request.

It is noted that, when the use method of the storage area 33 is considered from the viewpoint of the software or the program, the storage area 33 is not the single use method but differs depending on the use language of the program and the purpose. For example, the use methods of the storage area 33 in the above-mentioned two operation phases by the SMI-S control unit 32 respectively have the following tendencies. The calculation unit 324 previously estimates how much the program that repeatedly performs the memory expansion originally uses the memory area by using the following tendency. In other words, the calculation unit 324 determines the predetermined size of the reserved area based on the operation phase of the program of the request source of the first expansion request.

(A-2) Case of the Operation Phase at the Time of the Program Start (Initial Setting Phase).

The SMI-S control unit 32 performs the operation as described in the above-mentioned (A-1). The memory area acquired by the memory management unit 32a at this time is often supposed to be continuously used in the subsequent program, and a majority of these memory areas is not released to be continuously used until the end of the program in many cases.

(B-2) Case of the Operation Phase at the Time of the Program Operation (Normal Operation Phase).

The SMI-S control unit 32 performs the operation as described in the above-mentioned (B-1). The memory area acquired by the memory management unit 32a at this time is basically released in many cases when the command operation is completed, and the memory area continuously used until the end of the program hardly exists.

It is noted that In the following descriptions, the initial setting phase described in the above-mentioned (A-1) and (A-2) is referred to as (A), and the normal operation phase described in the above-mentioned (B-1) and (B-2) is referred to as (B) in some cases.

Although the above-mentioned difference exists on the program side, it is difficult to recognize how the program at the calling source is operated and how the acquired memory area is used in the memory management by the memory management unit 32a.

For this reason, when the memory expansion request is received, the calculation unit 324 may determine a memory expanded size (expanded_size) estimated to be thereafter used by the program while the following information that can be grasped by the memory management is used as an input.
Size of the current memory area (allocated_size) at the time of the reception of the expansion request of the memory area
Requested size (realloc_size) of the memory expansion request
Time (second) (realloc_time) since the memory expansion request is received until the next memory expansion request related to the memory area is received
Elapsed time (Total_Time) from the program activation or internal state flag (Flag) with which the above-mentioned (A) and (B) can be determined

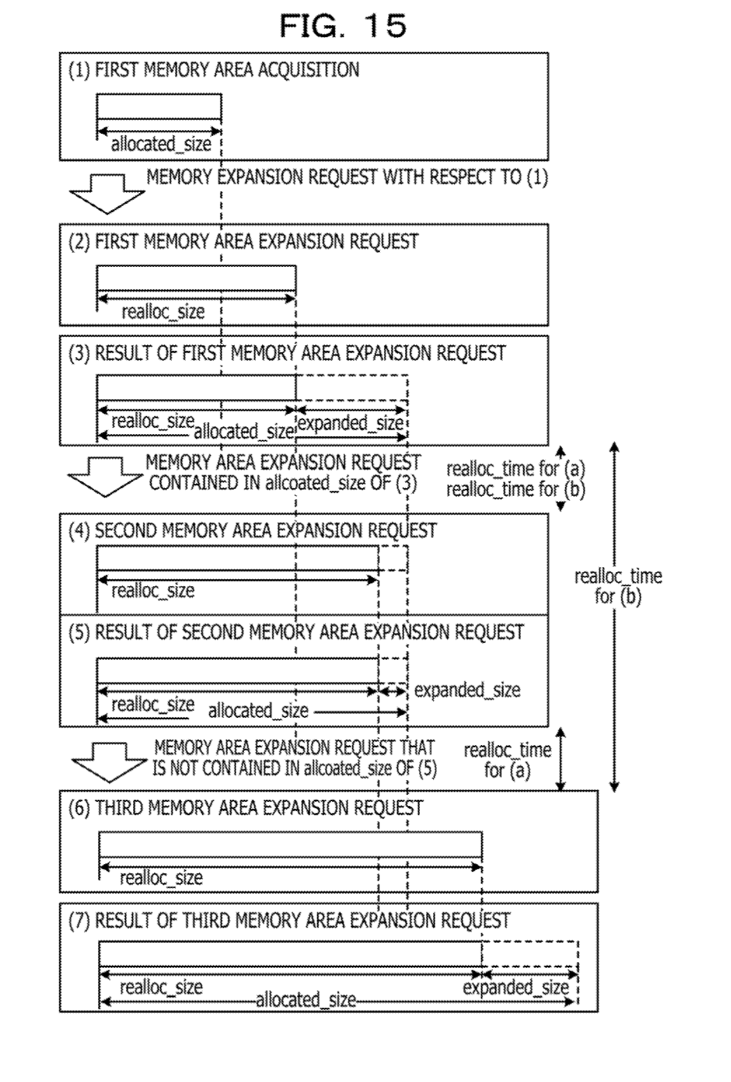

FIG. 15 illustrates an example of the expansion procedure of the memory area. Hereinafter, an example of the memory acquisition procedure by the memory management unit 32a according to the one exemplary embodiment will be described with reference to FIG. 15.

As illustrated in FIG. 15, the memory acquisition unit 321 of the memory management unit 32a acquires the memory area in accordance with the first memory area the acquisition request (see (1) of FIG. 15). At this time, the calculation unit 324 obtains the “allocated_size” corresponding to the size of the acquired memory area. The “allocated_size” may be, for example, the size specified by the memory acquisition request.

The memory expansion unit 322 of the memory management unit 32a receives the first memory area expansion request with respect to the memory area of (1) (see (2)). Then, the memory expansion unit 322 acquires an area including not only the “realloc_size” specified by the expansion request but also the “expanded_size” calculated by the calculation unit 324 (see (3)). That is, the “allocated_size” obtained by adding the “realloc_size” with the “expanded_size” is acquired as the result of the first memory area expansion.

It is noted that the “expanded_size” may be treated as the reserved area that may be released in accordance with the use situation of the memory area by the program.

The memory management unit 32a receives the second memory area expansion request with respect to the memory area of (3) (see (4)). It is noted that the “realloc_size” contained in the “allocated_size” (realloc_size+expanded_size”) of (3) is specified in the second expansion request.

In this case, the memory expansion unit 322 acquires the “realloc_size” specified by the second expansion request within a range that is contained in the “allocated_size” of (3) (see (5)). In this case, the “expanded_size” as the result of the second expansion request becomes a size obtained by subtracting the “realloc_size” specified by the second expansion request from the “allocated_size” as the result of the first expansion request. At this time, since the “expanded_size” is used for the expansion of the memory area related to the second expansion request, the acquisition of the new memory area does not occur, and the update of the “allocated_size” does not also occur.

The memory management unit 32a receives the third memory area expansion request with respect to the memory area of (5) (see (6)). It is noted that the “realloc_size” that is not contained in the “allocated_size” (realloc_size+expanded_size”) of (5) is specified in the third expansion request.

In this case, the memory expansion unit 322 acquires an area including not only the “realloc_size” specified by the expansion request of (5) but also the “expanded_size” calculated (updated) by the calculation unit 324 based on the “realloc_size” (see (7)). That is, the “allocated_size” obtained by adding the “realloc_size” with the newly calculated “expanded_size” is acquired as the result of the third memory area expansion.

With regard to the subsequent memory area expansion request too, the processing exemplified in the above-mentioned (4) and (5) or (6) and (7) may be performed depending on whether or not the “realloc_size” is contained in the immediately preceding “allocated_size”.

It is noted that, when the certain time has elapsed from the starting point in accordance with the operation phase of the SMI-S control unit 32 as described above, the memory release unit 323 of the memory management unit 32a may release the memory area.

For example, in a case where the operation phase of the SMI-S control unit 32 is (A) (initial setting phase), the memory release unit 323 may count the elapsed time “realloc_time” since the immediately preceding memory area expansion is performed (see “realloc_time for (A)” of FIG. 15). When the “realloc_time” has elapsed the certain time, the memory release unit 323 may release the memory area by the amount corresponding to the “expanded_size” out of the “allocated_size”.

On the other hand, in a case where the operation phase of the SMI-S control unit 32 is (B) (normal operation phase), the memory release unit 323 may count the elapsed time “realloc_time” since the first memory area expansion is performed (see “realloc_time for (B)” of FIG. 15). Then, when the “realloc_time” has elapsed the certain time, the memory release unit 323 may release the memory area by the amount corresponding to the “expanded_size” out of the “allocated_size”.

It is noted that the memory release unit 323 may determine, for example, that the operation phase is (A) when the elapsed time (Total_Time) from the program activation is within the predetermined time and the operation phase is (B) when he elapsed time (Total_Time) has elapsed the predetermined time. Alternatively, the memory release unit 323 may determine the operation phase based on the internal state flag (Flag) with which the above-mentioned (A) and (B) can be determined. The internal state flag may be managed and updated by the SMI-S control unit 32.

[1-3] Operation Example

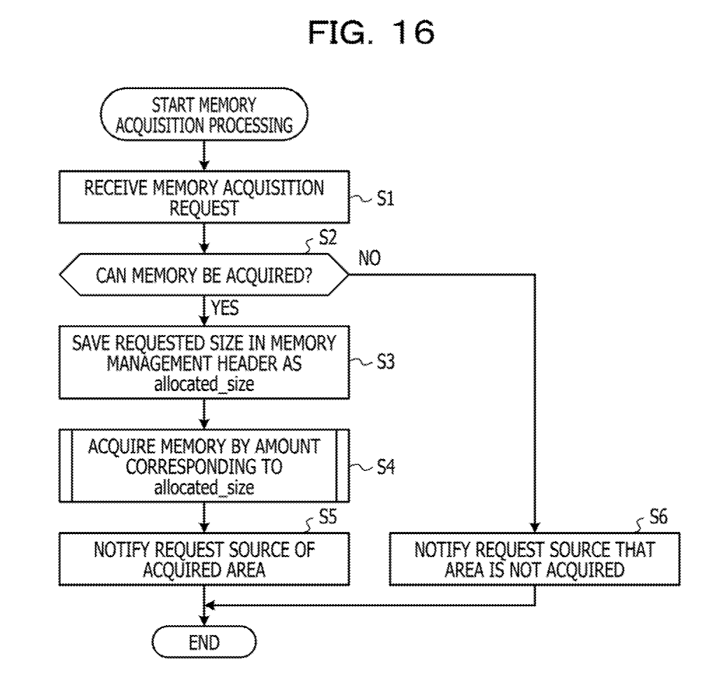

Next, the operation example of the thus configured storage apparatus 2 will be described with reference to FIGS. 16 to 26.

[1-3-1] Memory Acquisition Processing

First, an operation example of memory acquisition processing by the SMI-S control unit 32 of the control apparatus 3 will be described with reference to FIG. 16.

When the memory acquisition unit 321 receives the memory acquisition request (step S1), it is determined whether or not the memory area of the size specified by the acquisition request with respect to the free space of the storage area 33 can be acquired (step S2).

In a case where the memory area can be acquired (step S2: Yes), the memory acquisition unit 321 saves the requested size in a memory management header as the “allocated_size” (step S3).

Then, the memory acquisition unit 321 acquires the memory area by the amount corresponding to the “allocated_size” (step S4) and notifies the program or the like, which corresponds to the request source of the acquisition request, of the information of the acquired memory area (for example, the memory address or the like) (step S5), and the processing ends.

On the other hand, in a case where the memory area is not to be acquired (step S2: No), the memory acquisition unit 321 notifies the request source that the memory area is not acquired (step S6), and the processing ends.

As described above, the memory acquisition processing by the memory management unit 32a is ended.

It is noted that the acquisition processing of the memory area in step S4 may include a search for the free space, a data update of the management area by the securement of the memory area, a creation of the meta data based on the memory management header in step S3, or the like. The processing in step S4 may be similar to the above-mentioned acquisition processing, and the detailed descriptions thereof will be omitted.

[1-3-2] Memory Expansion Processing

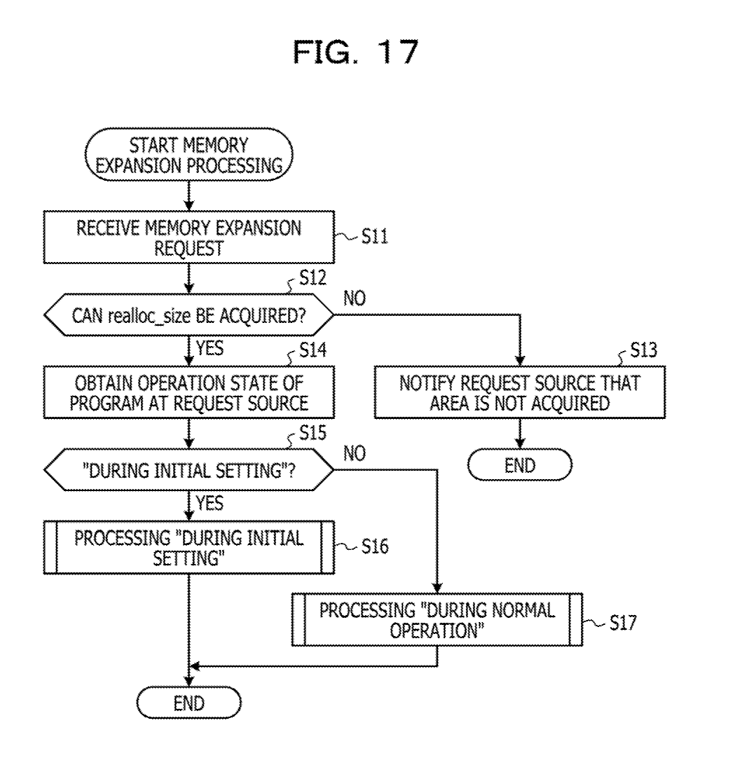

Next, an operation example of memory expansion processing by the SMI-S control unit 32 of the control apparatus 3 will be described with reference to FIG. 17.

When the memory expansion unit 322 receives the memory expansion request (step S11), the memory expansion unit 322 determines whether or not the memory area by the amount corresponding to the “realloc_size” specified by the expansion request with respect to the free space of the storage area 33 can be acquired (step S12).

In a case where the memory area by the amount corresponding to the “realloc_size” is not to be acquired (step S12: No), the memory expansion unit 322 notifies the request source that the memory area is not acquired (step S13), and the processing ends.

On the other hand, in a case where the memory area by the amount corresponding to the “realloc_size” can be acquired (step S12: Yes), the memory expansion unit 322 obtains the operation state of the program (operation phase) of the program corresponding to the request source such as, for example, the SMI-S control unit 32 (step S14).

For example, the memory expansion unit 322 may refer to the internal state flag (Flag) with which the above-mentioned (A) and (B) can be determined set in a predetermined location (the storage area 33 or the like) by the SMI-S control unit 32. Alternatively, the memory expansion unit 322 may obtain the elapsed time (Total_Time) from the program activation and determine the operation phase of the SMI-S control unit 32 by determining whether or not the elapsed time is shorter than a previously determined or measured processing time related to the initial setting.

In a case where the operation state of the program is “during the initial setting” (step S15: Yes), the SMI-S control unit 32 is in the initial setting phase. In this case, the memory expansion unit 322 performs the processing “during the initial setting” in cooperation with the calculation unit 324 (step S16), and the processing ends.

In a case where the operation state of the program is not “during the initial setting” (step S15: No), the SMI-S control unit 32 is in the normal operation phase. In this case, the memory expansion unit 322 performs the processing “during the normal operation” in cooperation with the calculation unit 324 (step S17), and the processing ends.

[1-3-3] the Processing “During the Initial Setting”

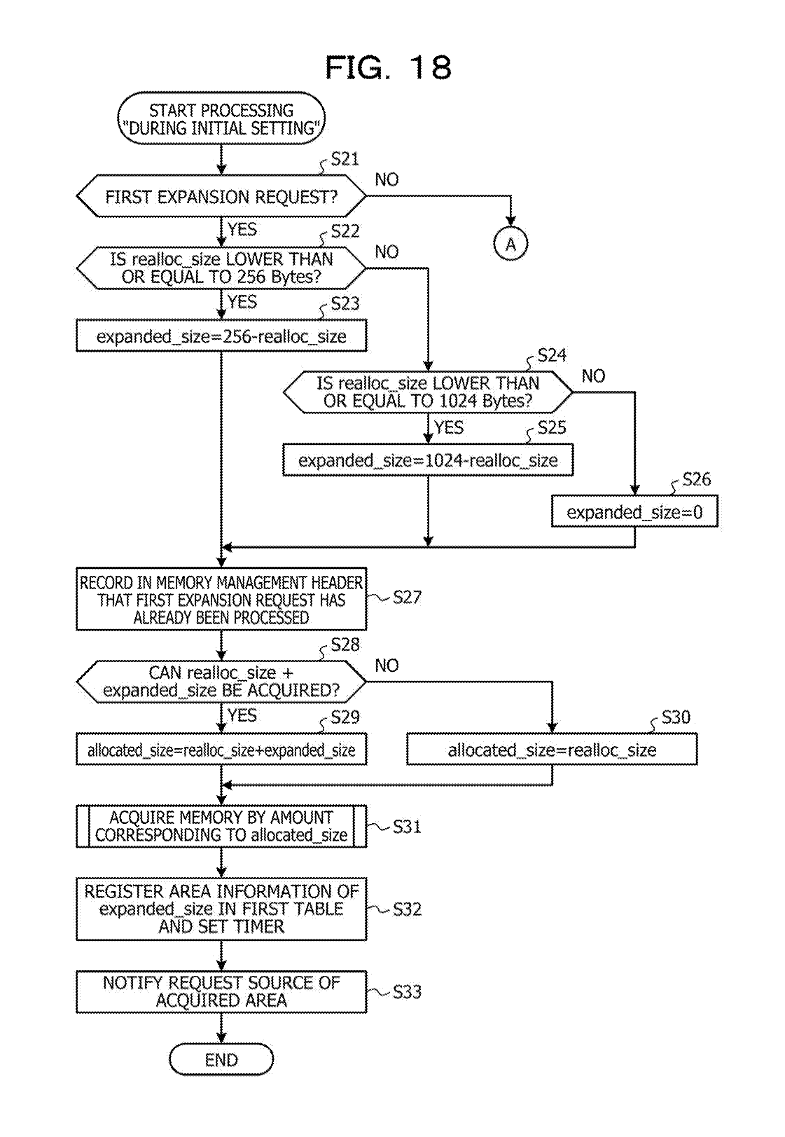

Next, an operation example of the processing “during the initial setting” in step S16 of FIG. 17 will be described with reference to FIGS. 18 to 20.

As illustrated in FIG. 18, the calculation unit 324 of the SMI-S control unit 32 determines whether or not this is a first expansion request (step S21), and in the case of the first expansion request (step S21: Yes), the calculation unit 324 determines whether or not the “realloc_size” is lower than or equal to 256 Bytes (step S22). It is noted that the calculation unit 324 may determine the presence or absence of the first expansion request by referring to the memory management header of the memory area where the expansion request has been issued.

In a case where the “realloc_size” is lower than or equal to 256 Bytes (step S22: Yes), the calculation unit 324 sets “256−realloc_size” In the “expanded_size” (step S23), and the processing shifts to step S27.

The probability that the data smaller than or equal to 256 Bytes for expanding the memory area according to SMI-S is a character string is high, and the “realloc_size+expanded_size” is set as the maximum size of the character string in many cases. For this reason, in a case where the “realloc_size” is lower than or equal to 256 Bytes, the calculation unit 324 sets the “expanded_size” such that the size becomes 256 Bytes.

In a case where the “realloc_size” is not lower than or equal to 256 Bytes (step S22: No), the calculation unit 324 determines whether or not the “realloc_size” is lower than or equal to 1024 Bytes (step S24).

In a case where the “realloc_size” is lower than or equal to 1024 Bytes (step S24: Yes), the calculation unit 324 sets the “1024−realloc_size” in the “expanded_size” (step S25), and the processing shifts to step S27.

The probability that the data smaller than or equal to 1024 Bytes for expanding the memory area according to SMI-S is data having the maximum value of 1024 Bytes as the response data is high. For this reason, the calculation unit 324 sets the “expanded_size” such that the “realloc_size+expanded_size” becomes 1024 Bytes corresponding to the maximum value of the data.

In a case where the “realloc_size” is not lower than or equal to 1024 Bytes (step S24: No), the calculation unit 324 sets “0” in the “expanded_size” (step S26), and the processing shifts to step S27.

In a case where the “realloc_size” is higher than 1024 Bytes, the probability that the memory area is the buffer secured by the consolidation on the program side to some extent. For this reason, the calculation unit 324 sets “0” in the “expanded_size” and secures only the size specified by the expansion request.

In step S27, the memory expansion unit 322 records that the first expansion request has been already processed in the memory management header of the memory area where the expansion request has been issued.

Next, the memory expansion unit 322 determines whether or not the memory area of the “realloc_size+expanded_size” can be acquired from the storage area 33 (step S28). In a case where the memory area can be acquired (step S28: Yes), the memory expansion unit 322 sets the “realloc_size+expanded_size” in the “allocated_size” (step S29), and the processing shifts to step S31.

On the other hand, in a case where the memory area having the “realloc_size+expanded_size” is not to be acquired from the storage area 33 (step S28: No), the memory expansion unit 322 sets the “realloc_size” in the “allocated_size” (step S30), and the processing shifts to step S31.

In step S31, the memory expansion unit 322 acquires the memory area by the amount corresponding to the “allocated_size” from the storage area 33.

Next, the memory expansion unit 322 registers the area information of the “expanded_size” in the first table 331 where the expanded memory area during the initial setting is monitored and sets the timer (step S32).

Then, the memory expansion unit 322 notifies the program, which corresponds to the request source of the expansion request, of the acquired memory area (step S33), and the processing ends.

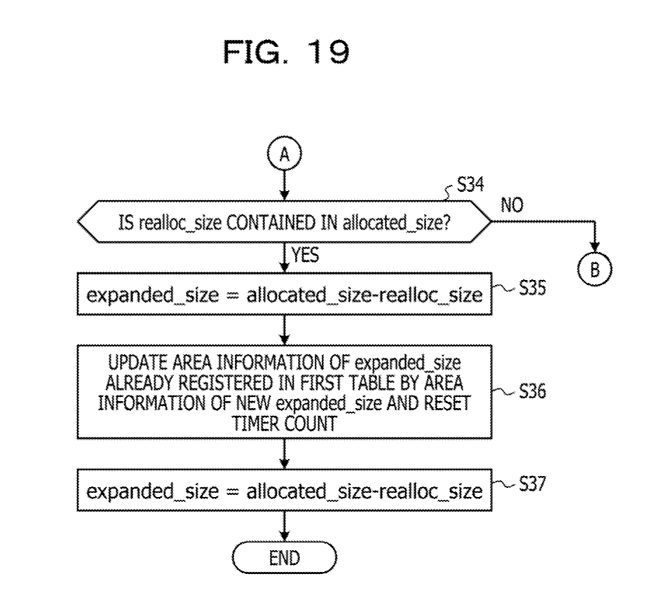

Herein, in step S21, in a case where this is not the first expansion request (step S21: No), as illustrated in FIG. 19, the memory expansion unit 322 determines whether or not the “realloc_size” is contained in the “allocated_size” (step S34).

In a case where the “realloc_size” is contained in the “allocated_size” (step S34: Yes), the expansion request can be processed in the memory area of the existing “allocated_size”. The memory expansion unit 322 sets the “allocated_size-realloc_size” in the “expanded_size” (step S35).

The memory expansion unit 322 also updates the first table 331 where the area information of the “expanded_size” already registered in the expanded memory area during the initial setting is monitored into the new “expanded_size” updated in step S35 and resets the timer count (step S36).

Then, the memory expansion unit 322 notifies the program, which corresponds to the request source of the expansion request, of the already established memory area (step S37), and the processing ends.

On the other hand, in step S34, in a case where the “realloc_size” is not contained in the “allocated_size” (step S34: No), the memory expansion is performed again since the “realloc_size” exceeds the secured reserved area. At this time, the calculation unit 324 sets a still higher value in the “expanded_size” since the memory area secured at the time of the first expansion request runs short (is insufficient).

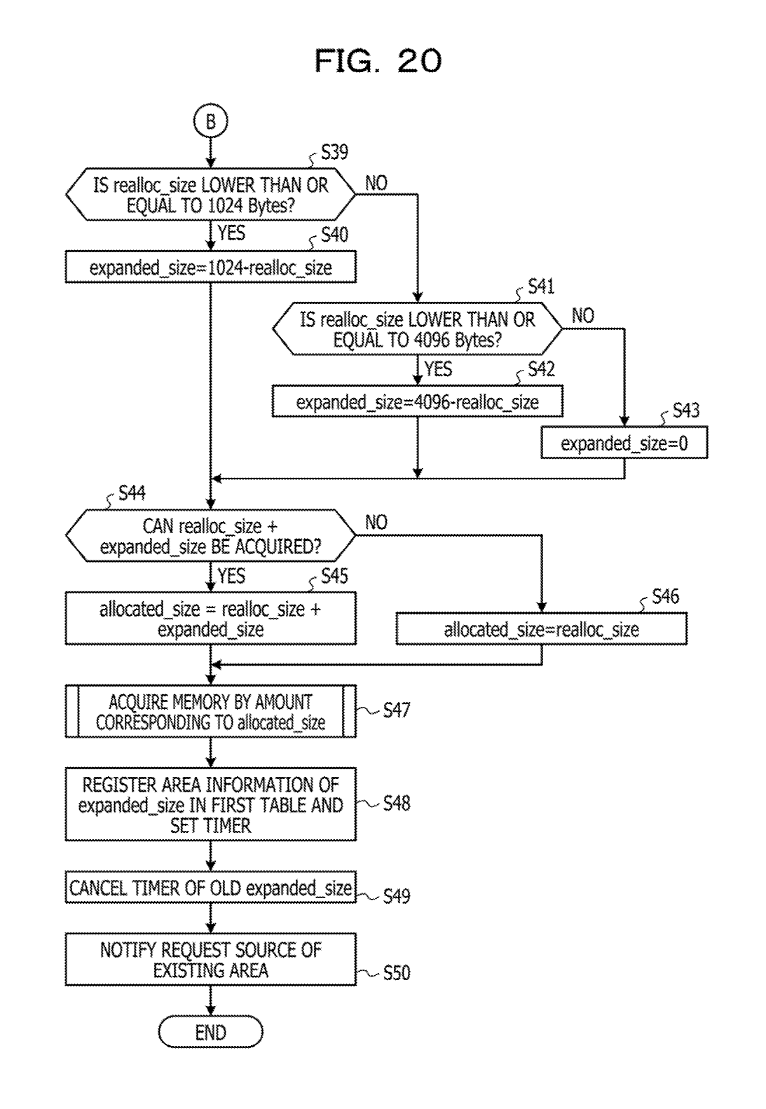

In this case, as illustrated in FIG. 20, the calculation unit 324 determines whether or not the “realloc_size” is lower than or equal to 1024 Bytes (step S39).

In a case where the “realloc_size” is lower than or equal to 1024 Bytes (step S39: Yes), the calculation unit 324 sets the “1024−realloc_size” in the “expanded_size” (step S40), and the processing shifts to step S44.

The probability that the data smaller than or equal to 1024 Bytes for expanding the memory area according to SMI-S is data having the maximum value of 1024 Bytes as the response data is high. For this reason, the calculation unit 324 sets the “expanded_size” such that the “realloc_size+expanded_size” becomes 1024 Bytes corresponding to the maximum value of the data. It is noted that the probability that the memory area where the processing in step S40 is performed is the memory area where the processing in step S23 (see FIG. 18) is performed in the first expansion request is high.

In a case where the “realloc_size” is not lower than or equal to 1024 Bytes (step S39: No), the calculation unit 324 determines whether or not the “realloc_size” is lower than or equal to 4096 Bytes (step S41).

In a case where the “realloc_size” is lower than or equal to 4096 Bytes (step S41: Yes), the calculation unit 324 sets “4096−realloc_size” in the “expanded_size” (step S42), and the processing shifts to step $44.

That is, in a case where the “realloc_size” is lower than or equal to 4096 Bytes, the calculation unit 324 sets the “expanded_size” such that the “realloc_size+expanded_size” becomes 4096 Bytes. It is noted that the probability that the memory area where the processing in step S42 is performed is the memory area where the processing in step S25 (see FIG. 18) is performed in the first expansion request is high.

In a case where the “realloc_size” is not lower than or equal to 4096 Bytes (step S41: No), the calculation unit 324 sets “0” in the “expanded_size” (step S43), and the processing shifts to step S44. That is, the calculation unit 324 sets “0” in the “expanded_size” and secures only the size specified by the expansion request.

In step S44, the memory expansion unit 322 determines whether or not the memory area of the “realloc_size+expanded_size” can be acquired from the storage area 33. In a case where the memory area can be acquired (step S44: Yes), the memory expansion unit 322 sets the “realloc_size+expanded_size” in the “allocated_size” (step S45), and the processing shifts to step S47.

On the other hand, in a case where the memory area of the “realloc_size+expanded_size” is not to be acquired from the storage area 33 (step S44: No), the memory expansion unit 322 sets the “realloc_size” In the “allocated_size” (step S46), and the processing shifts to step S47.

In step S47, the memory expansion unit 322 acquires the memory area by the amount corresponding to the “allocated_size” from the storage area 33.

Next, the memory expansion unit 322 registers the area information of the “expanded_size” in the first table 331 where the expanded memory area during the initial setting is monitored and sets the timer (step S48).

The memory expansion unit 322 also cancels the timer of the old “expanded_size” with respect to the first table 331 (step S49). A technique for cancelling the timer includes, for example, a deletion of the entry in the first table 331, a setting for invalidating the timer of the entry, or the like.

Then, the memory expansion unit 322 notifies the program, which corresponds to the request source of the expansion request, of the acquired memory area (step S50), and the processing ends.

As described above, the SMI-S control unit 32 ends the memory expansion processing by the memory management unit 32a during the initial setting.

It is noted that steps S21 to S26 (FIG. 18), steps S34 and S35 (FIG. 19), and steps S39 to S43 (FIG. 20) described above are examples of determination processing of the “expanded_size”. In addition, steps S28 to S32 (FIG. 18), step S36 (FIG. 19), and steps S44 to S49 (FIG. 20) are examples of activation and stopping processing of the expanded memory monitoring timer.

[1-3-4] Processing “During the Normal Operation”

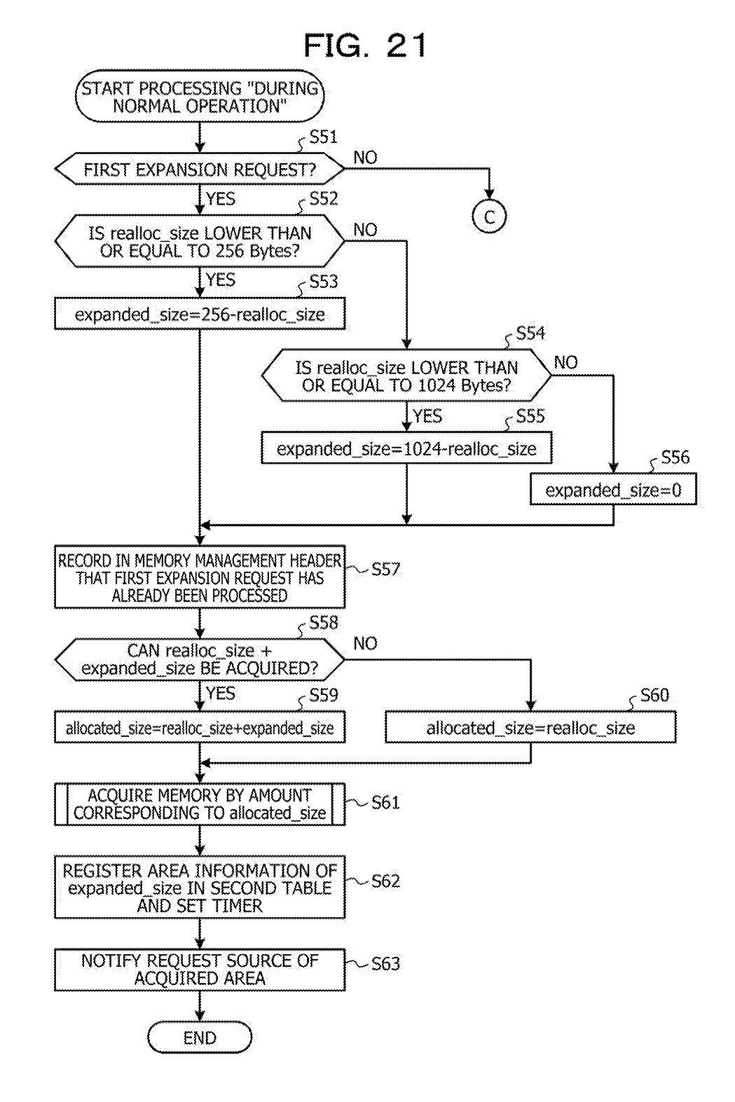

Next, an operation example of the processing “during the normal operation” illustrated in step S17 of FIG. 17 will be described with reference to FIGS. 21 to 23.

As illustrated in FIG. 21, the calculation unit 324 of the SMI-S control unit 32 determines whether or not this is a first expansion request (step S51), and in the case of the first expansion request (step S51: Yes), it is determined whether or not the “realloc_size” is lower than or equal to 256 Bytes (step S52). It is noted that the calculation unit 324 may determine the presence or absence of the first expansion request by referring to the memory management header of the memory area where the expansion request has been issued.

In a case where the “realloc_size” is lower than or equal to 256 Bytes (step S52: Yes), the calculation unit 324 sets “256−realloc_size” in the “expanded_size” (step S53), and the processing shifts to step S557.

The probability that the data smaller than or equal to 256 Bytes for expanding the memory area according to SMI-S is a character string is high, and the “realloc_size+expanded_size” is set as the maximum size of the character string in many cases. For this reason, in a case where the “realloc_size” is lower than or equal to 256 Bytes, the calculation unit 324 sets the “expanded_size” such that the size becomes 256 Bytes.

In a case where the “realloc_size” is not lower than or equal to 256 Bytes (step S52: No), the calculation unit 324 determines whether or not the “realloc_size” is lower than or equal to 1024 Bytes (step S54).

In a case where the “realloc_size” is lower than or equal to 1024 Bytes (step S54: Yes), the calculation unit 324 sets the “1024−realloc_size” in the “expanded_size” (step S55), and the processing shifts to step S57.

The probability that the data smaller than or equal to 1024 Bytes for expanding the memory area according to SMI-S is data having the maximum value of 1024 Bytes as the response data is high. For this reason, the calculation unit 324 sets the “expanded_size” such that the “realloc_size+expanded_size” becomes 1024 Bytes of the maximum value of the data.

In a case where the “realloc_size” is not lower than or equal to 1024 Bytes (step S54: No), the calculation unit 324 sets “0” in the “expanded_size” (step S56), and the processing shifts to step S57.

In a case where the “realloc_size” is higher than 1024 Bytes, the probability that the memory area is the buffer secured by the consolidation on the program side to some extent. For this reason, the calculation unit 324 sets “0” in the “expanded_size” and secures only the size specified by the expansion request.

In step S57, the memory expansion unit 322 records that the first expansion request has been already processed in the memory management header of the memory area where the expansion request has been issued.

Next, the memory expansion unit 322 determines whether or not the memory area of the “realloc_size+expanded_size” can be acquired from the storage area 33 (step S58). In a case where the memory area can be acquired (step S58: Yes), the memory expansion unit 322 sets the “realloc_size+expanded_size” in the “allocated_size” (step S59), and the processing shifts to step S61.

On the other hand, in a case where the memory area of the “realloc_size+expanded_size” is not to be acquired from the storage area 33 (step S58: No), the memory expansion unit 322 sets the “realloc_size” in the “allocated_size” (step S60), and the processing shifts to step S61.

In step S61, the memory expansion unit 322 acquires the memory area by the amount corresponding to the “allocated_size” from the storage area 33.

Next, the memory expansion unit 322 registers the area information of the “expanded_size” in the second table 332 where the expanded memory area during the normal operation is monitored and sets the timer (step S62).

Then, the memory expansion unit 322 notifies the program, which corresponds to the request source of the expansion request, of the acquired memory area (step S63), and the processing ends.

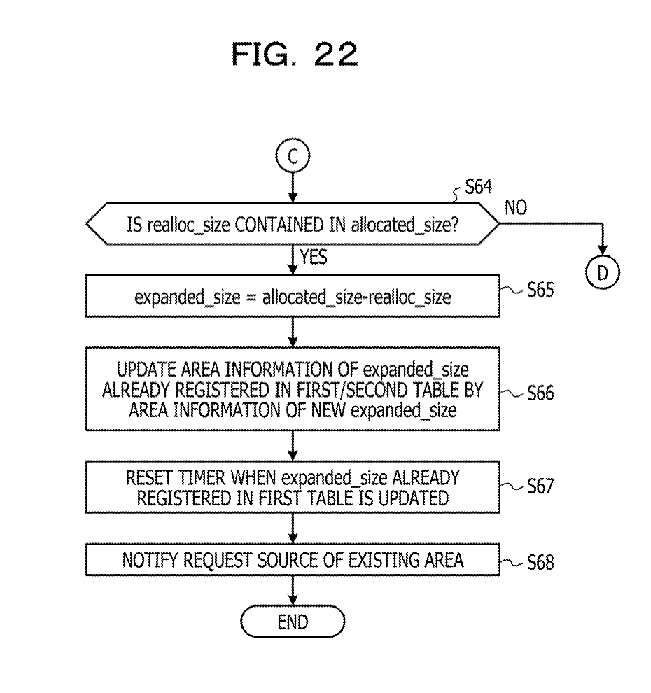

Herein, in step S51, in a case where this is not the first expansion request (step S51: No), as illustrated in FIG. 22, the memory expansion unit 322 determines whether or not the “realloc_size” is contained in the “allocated_size” (step S64).

In a case where the “realloc_size” is contained in the “allocated_size” (step S64: Yes), the expansion request can be processed in the memory area of the existing “allocated_size”. The memory expansion unit 322 sets the “allocated_size−realloc_size” in the “expanded_size” (step S65).

The memory expansion unit 322 also updates the area information of the “expanded_size” already registered in the first table 331 and/or the second table 332 into the new “expanded_size” updated in step S65 (step S66). A reason why one or both of the first table 331 and the second table 332 are updated is that the memory area secured during the initial setting may be expanded during the normal operation in some cases.

It is noted that, in a case where the area information of the “expanded_size” registered in the first table 331 is updated, the memory expansion unit 322 may update the area information by using a logic similar to the update processing during the initial setting. For example, in a case where the area information of the “expanded_size” registered in the first table 331 is updated, the memory expansion unit 322 resets the timer count (step S67). On the other hand, in a case where the area information of the “expanded_size” registered in the second table 332 is updated, the memory expansion unit 322 does not reset the timer count.

Then, the memory expansion unit 322 notifies the program, which corresponds to the request source of the expansion request, of the already established memory area (step S68), and the processing ends.

On the other hand, in step S64, in a case where the “realloc_size” is not contained in the “allocated_size” (step S64: No), the memory expansion is performed again since the “realloc_size” exceeds the secured reserved area. At this time, the calculation unit 324 sets a still higher value in the “expanded_size” since the memory area secured at the time of the first expansion request runs short (is insufficient).

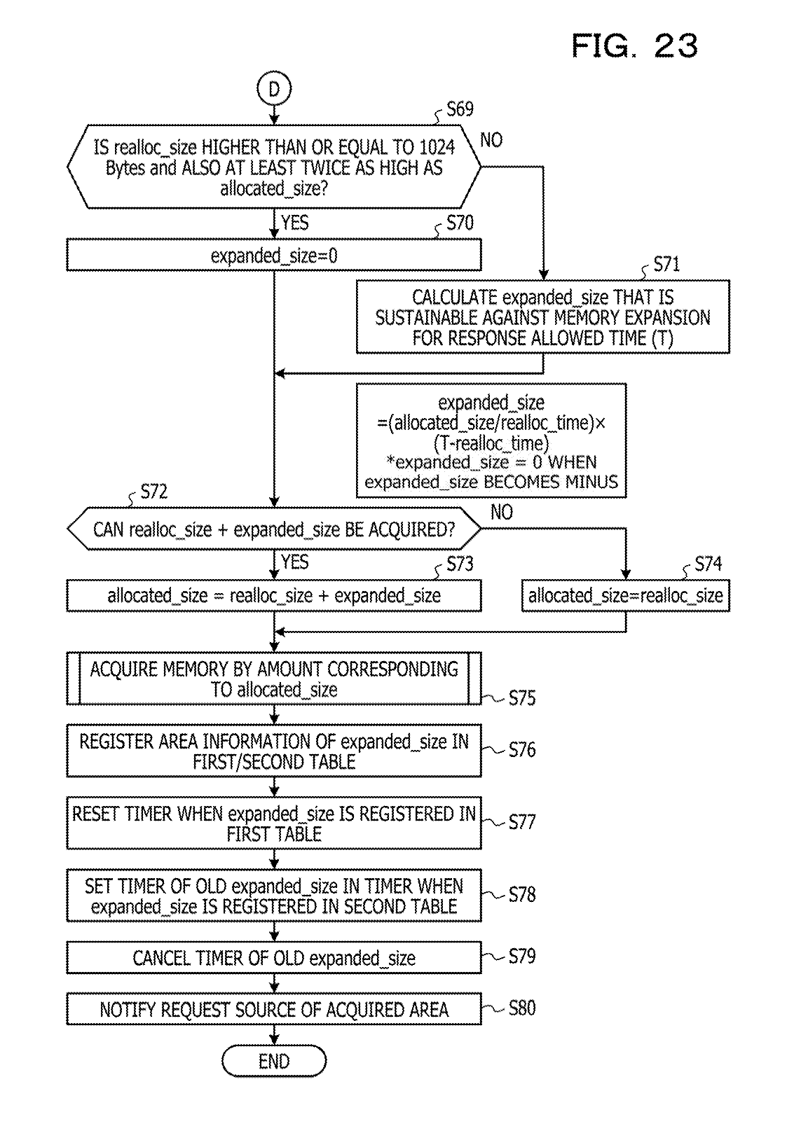

In this case, as illustrated in FIG. 23, the calculation unit 324 determines whether or not the “realloc_size” is higher than or equal to 1024 Bytes and also at least twice as high as the “allocated_size” (step S69).

In a case where the “realloc_size” is higher than or equal to 1024 Bytes and also at least twice as high as the “allocated_size” (step S69: Yes), the calculation unit 324 sets “0” in the “expanded_size” (step S70), and the processing shifts to step S72.

In a case where the “realloc_size” is higher than or equal to 1024 Bytes and also the “realloc_size” is at least twice as high as the “allocated_size”, the calculation unit 324 determines that the memory area larger than the memory area used by the program is attempted to be secured. In this case, according to a calculation technique of the “expanded_size” in which a particular size is set as a reference value, the probability that the larger memory area than supposed is secured is high. Therefore, the calculation unit 324 sets “0” in the “expanded_size” and secures only the size specified by the expansion request.

On the other hand, in a case where the “realloc_size” is not higher than or equal to 1024 Bytes or is not at least twice as high as the “allocated_size” (step S69: No), the processing shifts to step S71. In step S71, the calculation unit 324 calculates the “expanded_size” that is sustainable even in a case where the memory expansion continuously occurs during the response allowed time (T), and the processing shifts to step S72.

As described above, according to SMI-S, it is regulated that a response is to be made in 10 seconds with respect to the request from the client. For this reason, the calculation unit 324 determines a value of the “expanded_size” that is sustainable against the memory expansion for 10 seconds in total after the first memory expansion is performed.

For example, the calculation unit 324 may calculate the “expanded_size” by the following calculation.

expanded_size=(allocated_size/realloc_time)*(10−realloc_time)−realloc_size

Herein, “(allocated_size/realloc_time)” denotes the memory consumption per second in the above-mentioned calculation expression. In addition, “(10−realloc_time)” denotes a second count since the memory area is started to be expanded until 10 seconds (response allowed time) elapse, that is, the remaining second count from the current time. It is noted that the calculation unit 324 may set “0” in the “expanded_size” in a case where the “expanded_size” becomes minus.

In step S72, the memory expansion unit 322 determines whether or not the memory area of the “realloc_size+expanded_size” can be acquired from the storage area 33. In a case where the memory area can be acquired (step S72: Yes), the memory expansion unit 322 sets the “realloc_size+expanded_size” in the “allocated_.size” (step S73), and the processing shifts to step S75.

On the other hand, in a case where the memory area of the “realloc_size+expanded_size” is not to be acquired from the storage area 33 (step S72: No), the memory expansion unit 322 sets the “realloc_size” in the “allocated_size” (step S74), and the processing shifts to step S75.

In step S75, the memory expansion unit 322 acquires the memory area by the amount corresponding to the “allocated_size” from the storage area 33.

Next, the memory expansion unit 322 registers the area information of the new “expanded_size” in the first table 331 and/or the second table 332 (step S76). A reason why one or both of the first table 331 and the second table 332 are updated is that the memory area secured during the initial setting may be expanded during the normal operation in some cases.

It is noted that, in a case where the area information of the “expanded_size” is registered in the first table 331, the memory expansion unit 322 may update the area information by using a logic similar to the update processing during the initial setting. For example, in a case where the area information of the “expanded_size” is registered in the first table 331, the memory expansion unit 322 resets the timer count (step S77).

On the other hand, in a case where the area information of the “expanded_size” is registered in the second table 332, the memory expansion unit 322 sets a timer of the old “expanded_size” in the timer (step S78). That is, the memory expansion unit 322 sets the timer while the first expansion request is used as a trigger based on the logic of the above-mentioned (B-1) during the normal operation. In a case where the next expansion request is issued, the memory expansion unit 322 does not reset the count of the timer. To realize the above-mentioned logic, the memory expansion unit 322 carries on the timer count of the area information of the old “expanded_size” into the area information of the “expanded_size” registered in the second table 332.

The memory expansion unit 322 cancels the timer of the old “expanded_size” with respect to the first table 331 and/or the second table 332 (step S79). A technique for cancelling the timer includes, for example, a deletion of the entry in the first table 331 and/or the second table 332, a setting for invalidating the timer of the entry, or the like.

Then, the memory expansion unit 322 notifies the program, which corresponds to the request source of the expansion request, of the acquired memory area (step S80), and the processing ends. It is noted that the processing related to the second table 332 in steps S76, S78, and S79 may also be replaced with the following processing. For example, instead of acquiring the new entry with respect to the second table 332 to register the area information of the “expanded_size”, the memory expansion unit 322 may update and register the area information of the newly acquired area with respect to the entry of the old “expanded_size”.

As described above, the SMI-S control unit 32 ends the memory expansion processing by the memory management unit 32a during the normal operation.

It is noted that steps S51 to S56 (FIG. 21), steps S64 and S65 (FIG. 22), and steps S69 to S71 (FIG. 23) described above are examples of the determination processing of the “expanded_size”. In addition, steps S58 to A62 (FIG. 21), step S66 (FIG. 22), and steps S72 to S79 (FIG. 23) are examples of the activation and stopping processing of the expanded memory monitoring timer.

[1-3-5] Memory Release Processing

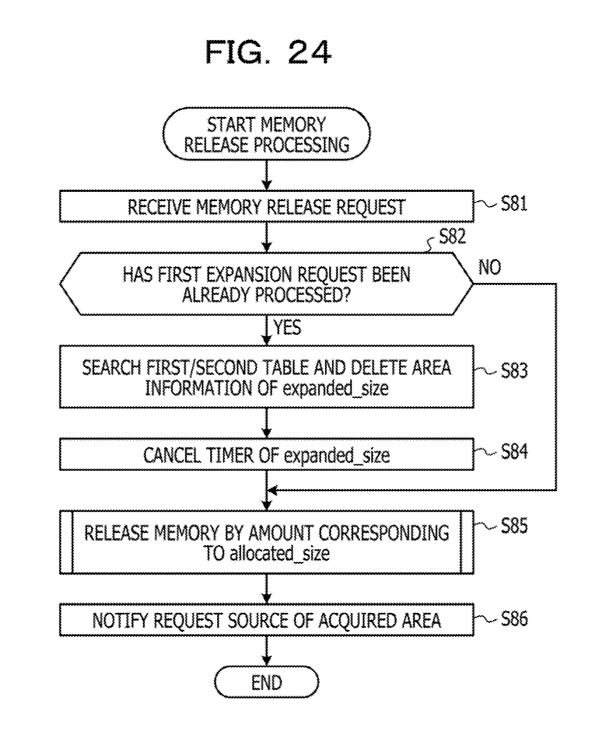

Next, an operation example of memory release processing by the SMI-S control unit 32 of the control apparatus 3 will be described with reference to FIG. 24.

When the memory release unit 323 receives the memory release request (step S81), the memory release unit 323 determines whether or not the first expansion request has been already processed with respect to the memory area instructed by the release request (memory area set as a release target) (step S82). It is noted that the memory release unit 323 may perform the determination in step S82 by referring to the memory management header registered in step S27 of FIG. 18, for example.

In a case where the first expansion request has been already processed (step S82: Yes), the processing shifts to step S85.

On the other hand, in a case where the first expansion request has not been already processed (step S82: No), the memory release unit 323 searches the first table 331 and/or the second table 332 to delete the area information of the “expanded_size” of the memory area set as the release target (step S83).

Then, the memory release unit 323 cancels the timer of the “expanded_size” (step S84), and the processing shifts to step S85.

In step S85, the memory release unit 323 releases the memory area by the amount corresponding to the “allocated_size” which is set as the release target.

Then, the memory release unit 323 notifies the program, which corresponds to the request source of the release request, of the released memory area (step S86), and the processing ends.

As described above, the memory release processing by the memory management unit 32a is ended.

It is noted that the release processing of the memory area in step S85 may include the update the meta data of the free memory area, the coupling of the free memories, or the like. The processing in step S85 may be similar to the release processing described above, and the detailed descriptions thereof will be omitted.

[1-3-6] Monitoring Processing

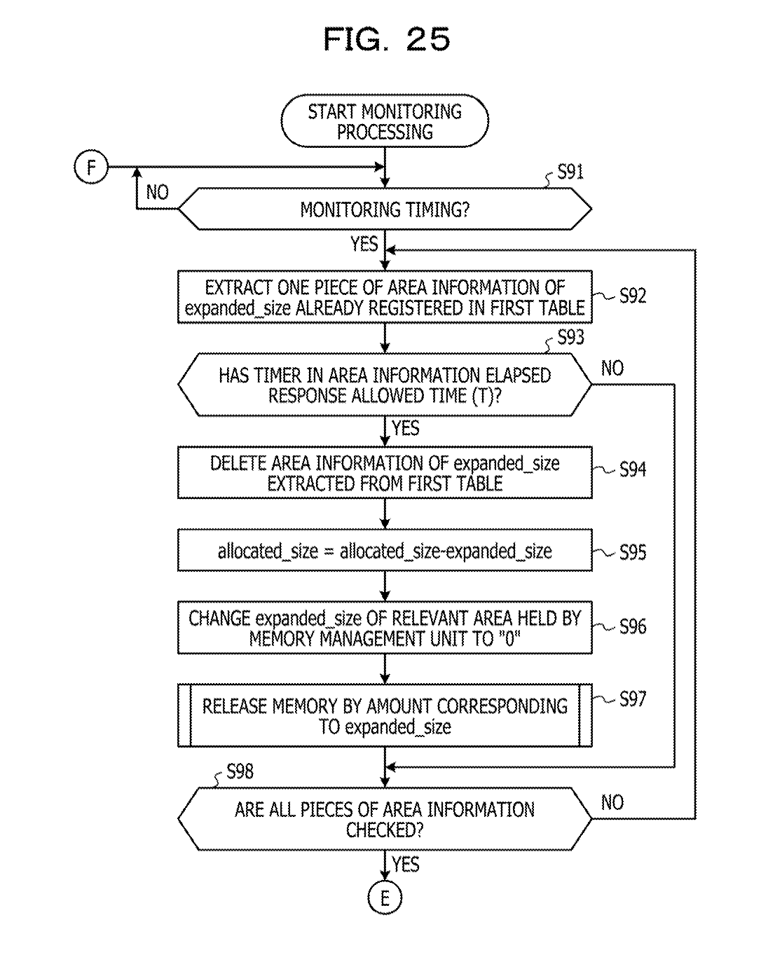

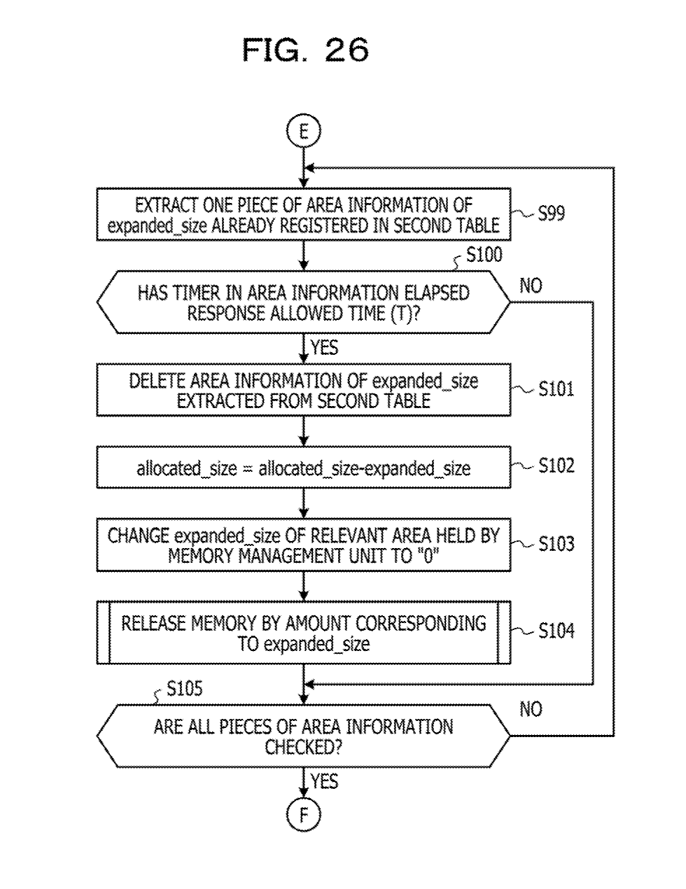

Next, an operation example of the monitoring processing of the memory area by the SMI-S control unit 32 of the control apparatus 3 will be described with reference to FIG. 25 and FIG. 26.

As illustrated in FIG. 25, the memory release unit 323 waits for a monitoring timing set for every certain period, for example, every second (step S91, step S91: No).

When the monitoring timing has arrived (step S91: Yes), the memory release unit 323 extracts one piece of area information of the “expanded_size” already registered in the first table 331(step S92).

Next, the memory release unit 323 determines whether or not the timer in the area information has elapsed the response allowed time (T) (step S93). In a case where the timer has not elapsed the response allowed time (T) (step S93: No), the processing shifts to step S98.

On the other hand, in a case where the timer has elapsed the response allowed time (T) (step S93: Yes), the memory release unit 323 deletes the area information of the “expanded_size” extracted from the first table 331 (step S94).

The memory release unit 323 also sets the “allocated_size−expanded_size” in the “allocated_size” (step S95) and changes the “expanded_size” of the meta data of the relevant memory area to “0” (step S96). It is noted that, since at least the “allocated_size” and the “realloc_size” are set in the meta data, the memory release unit 323 may also set the “allocated_size to have the same value as the “realloc_size” instead of the change of the “expanded_size” to “0”. In this case, a configuration may also be adopted in which the information of the “expanded_size” is not set in the meta data.

Then, the memory release unit 323 releases the memory area by the amount corresponding to the “expanded_size” (step S97), and the processing shifts to step S98.

In step S98, the memory release unit 323 determines whether or not all pieces of the area information are checked. In a case where all pieces of the area information are not checked (step S98: No), the processing shifts to step S92.

On the other hand, in a case where all pieces of the area information are checked (step S98: Yes), the processing shifts to step S99 of FIG. 26.

In step S99 of FIG. 26, the memory release unit 323 extracts one pieces of area information of the “expanded_size” already registered in the second table 332.

Next, the memory release unit 323 determines whether or not the timer in the area information has elapsed the response allowed time (T) (step S100). In a case where the timer has not elapsed the response allowed time (T) (step S100: No), the processing shifts to step S105.

On the other hand, in a case where the timer has elapsed the response allowed time (T) (step S100: Yes), the memory release unit 323 deletes the area information of the “expanded_size” extracted from the second table 332 (step S101).

The memory release unit 323 also sets the “allocated_size−expanded_size” in the “allocated_size” (step S102) and changes the “expanded_size” of the meta data of the relevant memory area to “0” (step S103). It is noted that, for a reason similar to step S96, the memory release unit 323 may set the “allocated_size to have the same value as the “realloc_size” instead of the change of the “expanded_size” to “O”. In this case, a configuration may also be adopted in which the information of the “expanded_size” is not set in the meta data.

Then, the memory release unit 323 releases the memory area by the amount corresponding to the “expanded_size” (step S104), and the processing shifts to step S105.

In step S105, the memory release unit 323 determines whether or not all pieces of area information are checked. In a case where all pieces of area information are not checked (step S105: No), the processing shifts to step S99.

On the other hand, in a case where all pieces of area information are checked (step S105: Yes), the processing shifts to step S91 of FIG. 25.

As described above, the monitoring processing of the memory area by the memory management unit 32a is ended.

It is noted that the release processing of the memory area in steps S97 and S104 may include the update the meta data of the free memory area, the coupling of the free memories, or the like. The processing in steps S97 and S104 may be similar to the above-mentioned release processing, and the detailed descriptions thereof will be omitted.

As described above, with the storage apparatus 2 according to the one exemplary embodiment, the memory management is appropriately processed at the time of the realloc process in an environment to which SMI-S is applied.

For example, the memory management unit 32a decreases the number of memory copies at the time of the realloc process of the memory area to avoid the performance degradation and can also reduce the excessive memory size. The memory management unit 32a can also use the limited resources with as little waste as possible by also taking the fragmentation of the memory area into account.

Therefore, the SMI-S control unit 32 can acquire the storage area (memory area) of the desired size in the memory.

### [2] Others

The technology according to the above-described one exemplary embodiment can be modified or altered to be implemented as follows.

For example, the respective function blocks of the control apparatus 3 illustrated in FIG. 11 may be consolidated In respectively arbitrary combinations or may also be divided.

In addition, the functions of the control apparatus 3 may be realized by the processor 3a of a multi-processor or multi-core type.

Furthermore, according to the above-described one exemplary embodiment, the descriptions have been provided in a case where the controller 11 illustrated in FIG. 7 is the SMI-S control unit 32 illustrated in FIG. 11, but the configuration is not limited to this. The controller 11 may be mounted to various apparatuses that use the memory 13. In addition, the determination, update, deletion, and the like of the “expanded_size” in the above descriptions may be realized by various techniques while characteristics of a program and a language of a calling source of the memory management are utilized.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a memory; and
a processor coupled to the memory and configured to:
set, in the memory, a first region having a first capacity;
receive a first request which requests to change the first region to a second region having a second capacity greater than the first capacity;
set, in the memory, the second region and a reserved region in response to the first request; and
cancel a setting of the reserved region when a second request which requests to change the second region to a third region having a third capacity greater than the second capacity is not received within a first time period after the first request is received.

2. The information processing apparatus according to claim 1, wherein
the processor is configured to set the third region by using at least a part of the reserved region when the second request is received within the first time period after the first request is received.

3. The information processing apparatus according to claim 2, wherein
the second region includes the first region and a fourth region adjacent to the first region, and
the reserved region is adjacent to the second region.

4. The information processing apparatus according to claim 3, wherein
the processor is configured to:
determine the second capacity based on the first request; and
determine a fourth capacity of the reserved region based on a difference between the second capacity and the first capacity.

5. The information processing apparatus according to claim 4, wherein
the processor is configured to:
determine whether a first total value of the second capacity and the fourth capacity is less than the third capacity when the second request is received within the first time period after the first request is received; and
change the reserved region when the first total value is less than the third capacity.

6. The information processing apparatus according to claim 5, wherein
the processor is configured to set the third region by using at least part of the reserved region and the second region when the first total value is greater than or equal to the third capacity.

7. The information processing apparatus according to claim 5, wherein
the processor is configured to determine the fourth capacity based on an operation phase of a program at a request source of the first request.

8. The information processing apparatus according to claim 5, wherein
the processor is configured to:
reset a timer for measuring the first time period when a processing related to the first request is executed when the operation phase is an initial setting phase, and
cancel the setting of the reserved region when the second request is not received within the first time period after the processing related to the first request is executed.

9. The information processing apparatus according to claim 7, wherein
the processor is configured to cancel the setting of the reserved region when the second request is not received within the first time period after a processing related to the first request is executed in a case where the operation phase is a normal operation phase.

10. The information processing apparatus according to claim 4, wherein
the processor is configured to reallocate the first region to a vacant contiguous region having at least the second capacity in a case where the second region is not to be set in the first region and a free space contiguous to the first region.

11. A method comprising:
setting, in a memory, a first region having a first capacity;
receiving a first request which requests to change the first region to a second region having a second capacity greater than the first capacity;
setting, in the memory, the second region and a reserved region in response to the first request; and
cancelling a setting of the reserved region when a second request which requests to change the second region to a third region having a third capacity greater than the second capacity is not received within a first time period after the first request is received.

12. The method according to claim 11, further comprising:
when the second request is received within the first time period after the first request is received, setting the third region by using at least a part of the reserved region.

13. The method according to claim 12, wherein
the second region includes the first region and a fourth region adjacent to the first region, and
the reserved region is adjacent to the second region.

14. The method according to claim 13, further comprising:
determining the second capacity based on the first request; and
determining a fourth capacity of the reserved region based on a difference between the second capacity and the first capacity.

15. The method according to claim 14, further comprising:
determining whether a first total value of the second capacity and the fourth capacity is less than the third capacity when the second request is received within the first time period after the first request is received; and
changing the reserved region when the first total value is less than the third capacity.

16. A non-transitory computer-readable storage medium storing a program that causes an information processing apparatus to execute a process, the process comprising:
setting, in a memory, a first region having a first capacity;
receiving a first request which requests to change the first region to a second region having a second capacity greater than the first capacity;
setting, in the memory, the second region and a reserved region in response to the first request; and
cancelling a setting of the reserved region when a second request which requests to change the second region to a third region having a third capacity greater than the second capacity is not received within a first time period after the first request is received.

17. The non-transitory computer-readable storage medium according to claim 16, the process further comprising:
when the second request is received within the first time period after the first request is received, setting the third region by using at least a part of the reserved region.

18. The non-transitory computer-readable storage medium according to claim 12, wherein
the second region includes the first region and a fourth region adjacent to the first region, and
the reserved region is adjacent to the second region.

19. The non-transitory computer-readable storage medium according to claim 18, the process further comprising:
determining the second capacity based on the first request; and
determining a fourth capacity of the reserved region based on a difference between the second capacity and the first capacity.

20. The non-transitory computer-readable storage medium according to claim 19, the process further comprising:
determining whether a first total value of the second capacity and the fourth capacity is less than the third capacity when the second request is received within the first time period after the first request is received; and
changing the reserved region when the first total value is less than the third capacity.
